(19) United States
(12) Patent Application Publication
(10) Pub. No.: US 2013/0183589 A1
(43) Pub. Date: Jul. 18, 2013

(54) BATTERY SINTERED BODY, PRODUCING METHOD OF BATTERY SINTERED BODY AND ALL SOLID LITHIUM BATTERY

(71) Applicants: Yoshitaka Minamida, Susono-shi (JP); Chihiro Yada, Susono-shi (JP); Keiichi Kohama, Mishima-shi (JP)

(72) Inventors: Yoshitaka Minamida, Susono-shi (JP); Chihiro Yada, Susono-shi (JP); Keiichi Kohama, Mishima-shi (JP)

(73) Assignee: TOYOTA JIDOSHA KABUSHIKI KAISHA, Toyota-shi, Aichi (JP)

(21) Appl. No.: 13/820,777

(22) PCT Filed: Sep. 27, 2011
(86) PCT No.: PCT/JP2011/072085

§ 371 Date: Mar. 28, 2013

(30) Foreign Application Priority Data
Sep. 28, 2010 (JP) 2010-217028

(51) Int. Cl. H01M 10/0562; H01M 10/052

(52) U.S. Cl. CPC H01M 10/0562; H01M 10/052
USPC 429/319; 429/304; 429/322

(57) ABSTRACT

A battery sintered body, in which charge-discharge properties are restrained from deteriorating in accordance with sintering, and a producing method thereof. A battery sintered body includes: a phosphate compound of a nasicon type as a solid electrolyte material; and any one of an oxide of a spinel type containing at least one of Ni and Mn, LiCoO₂ and a transition metal oxide as an active material, wherein a component except a component of the above-mentioned solid electrolyte material and a component of the above-mentioned active material is not detected on an interface between the above-mentioned solid electrolyte material and the above-mentioned active material in analyzing by an X-ray diffraction method.

### TECHNICAL FIELD

The present invention relates to a battery sintered body in an all solid lithium secondary battery, such as a laminated body comprising a solid electrolyte layer and an active material layer, and an active material layer in which a solid electrolyte and an active material are mixed.

### BACKGROUND ART

In accordance with a rapid spread of information relevant apparatuses and communication apparatuses such as a personal computer, a video camera and a portable telephone in recent years, the development of a battery to be utilized as a power source thereof has been emphasized. The development of a high-output and high-capacity battery for an electric automobile or a hybrid automobile has been advanced also in the automobile industry. A lithium ion secondary battery has been presently noticed from the viewpoint of a high energy density among various kinds of batteries.

Liquid electrolyte containing a flammable organic solvent is used for a presently commercialized lithium ion secondary battery, so that the installation of a safety device for restraining temperature rise during a short circuit and the improvement in structure and material for preventing the short circuit are necessary therefor. On the contrary, an all solid lithium secondary battery all-solidified by replacing the liquid electrolyte with a solid electrolyte layer is conceived to intend the simplification of the safety device and be excellent in production cost and productivity for the reason that the flammable organic solvent is not used in the battery.

An all solid lithium secondary battery ordinarily comprises a cathode active material layer containing a cathode active material, an anode active material layer containing an anode active material, and a solid electrolyte layer formed between the cathode active material layer and the anode active material layer. A battery sintered body and a producing method thereof, such that a phosphate compound is used for a solid electrolyte layer and an oxide of a metal of at least one kind of Co, Ni, Mn and Fe is used for an active material layer, are disclosed in Patent Literature 1 as a battery sintered body used for an all solid lithium secondary battery and a producing method thereof.

In Patent Literature 2, an all solid state battery is disclosed which includes an electrode section such that an amorphous solid electrolyte having a relation of Ty>Tz and an electrode active material are mixed and burnt by heating when temperature at which an electrode active material is deducted in capacity is regarded as Ty and temperature at which a solid electrolyte material is burnt to shrinkage is regarded as Tz by a reaction of the solid electrolyte material and the electrode active material. Also, in Patent Literature 3, a laminated body for an all solid lithium secondary battery comprising an active material layer containing a crystalline material capable of emitting and storing Li ion, and a solid electrolyte layer containing a crystalline material having Li ion conductivity, which is joined to the above-mentioned active material layer by sintering, is disclosed in which a component except a component of the above-mentioned active material layer and a component of the above-mentioned solid electrolyte layer is not detected in analyzing by an X-ray diffraction method. Also, in Non Patent Literature 1, an all solid state battery of a laminate sintering type is disclosed which uses LAGP as a solid electrolyte material and uses TiO₂ as an anode active material.

### CITATION LIST

### Patent Literatures

Patent Literature 1: Japanese Patent Application Publication (JP) 2008-251225 A
Patent Literature 2: JP 2009-140911 A
Patent Literature 3: JP 2007-005279 A Non Patent Literature
Non Patent Literature 1: Makoto Yoshioka, Takeshi Hayashi, Masutaka Ouchi, Kunio Nishida, Koichi Watanabe, Hiroshi Takagi, “Development of the Co-fired Solid-State Battery with Nasicon Electrolyte”, the 51st Battery Symposium Preliminary Reports, Lecture Number 1G16, Heisei 22, p. 462

### SUMMARY OF INVENTION

### Technical Problem

However, for example, in the battery sintered body and the like of Patent Literatures 1 to 3, ions are prevented from moving for the reason that a heterogenous phase occurs on an interface between a solid electrolyte material and an active material in accordance with sintering of the battery sintered body and the like. Thus, the problem is that charge-discharge properties of the battery sintered body and the like deteriorate. In particular, in the case where sintering temperature of the battery sintered body and the like is high, the occurrence of a heterogenous phase becomes so more remarkable that this problem becomes more serious.

The present invention has been made in view of the above-mentioned problem, and the problem thereof is to provide a battery sintered body, in which charge-discharge properties are restrained from deteriorating in accordance with sintering, and a producing method thereof.

### Solution to Problem

In order to solve the above-mentioned problem, a first battery sintered body according to the present invention comprises: a phosphate compound of a nasicon type as a solid electrolyte material and an oxide of a spinel type containing at least one of Ni and Mn as an active material, characterized in that a component except a component of the above-mentioned solid electrolyte material and a component of the above-mentioned active material is not detected on an interface between the above-mentioned solid electrolyte material and the above-mentioned active material in analyzing by an X-ray diffraction method.

In the first battery sintered body, ions may move favorably. Thus, charge-discharge properties of the battery sintered body may be restrained from deteriorating.

An aspect of the first battery sintered body according to the present invention is characterized in that the above-mentioned active material is represented by the following general formula (1):

LiM1Mn₂₋ₓO₄ (1)

(in the above-mentioned general formula (1), M1 is at least one kind selected from the group consisting of Cr, Fe, Co, Ni and Cu, and “x” is 0≦x<2).

According to this aspect, ions may move favorably. Thus, charge-discharge properties of the battery sintered body may be restrained from deteriorating.

Another aspect of the first battery sintered body according to the present invention is characterized in that the above-mentioned active material is LiNi_{0.5}Mn_{1.5}O₄.

According to this aspect, the battery sintered body, in which charge-discharge properties are restrained from deteriorating in accordance with sintering, may be obtained as described in the after-mentioned example.

A second battery sintered body according to the present invention comprises: a phosphate compound of a nasicon type as a solid electrolyte material and LiCoO₂ as an active material, characterized in that a component except a component of the above-mentioned solid electrolyte material and a component of the above-mentioned active material is not detected on an interface between the above-mentioned solid electrolyte material and the above-mentioned active material in analyzing by an X-ray diffraction method.

In the second battery sintered body, ions may move favorably. Thus, charge-discharge properties of the battery sintered body may be restrained from deteriorating.

A third battery sintered body according to the present invention comprises: a phosphate compound of a nasicon type as a solid electrolyte material and a transition metal oxide represented by the following general formula (2) as an active material, characterized in that a component except a component of the above-mentioned solid electrolyte material and a component of the above-mentioned active material is not detected on an interface between the above-mentioned solid electrolyte material and the above-mentioned active material in analyzing by an X-ray diffraction method:

M2_{y1}O_{y2} (2)

(in the above-mentioned general formula (2), M2 is a transition metal element except Ti and has the largest possible valence, and y1 and y2 are 0≦y1 and 0≦y2).

In the third battery sintered body, ions may move favorably. Thus, charge-discharge properties of the battery sintered body may be restrained from deteriorating.

Another aspect of the third battery sintered body according to the present invention is characterized in that the above-mentioned active material is Nb₂O₅.

Another aspect of the third battery sintered body according to the present invention is characterized in that the above-mentioned active material is WO₃.

Yet another aspect of the third battery sintered body according to the present invention is characterized in that the above-mentioned active material is MoO₃.

Still another aspect of the third battery sintered body according to the present invention is characterized in that the above-mentioned active material is Ta₂O₅.

Another aspect of any one of the first to third battery sintered bodies according to the present invention is characterized in that the above-mentioned solid electrolyte material is represented by the following general formula (3):

Li_{1+z}M3_{z}M4_{2-z}(PO₄)₃ (3)

(in the above-mentioned general formula (3), M3 is at least one kind selected from the group consisting of Al, Y, Ga and In, M4 is at least one kind selected from the group consisting of Ti, Ge and Zr, and “z” is 0≦z≦2).

According to this aspect, ions may move favorably. Thus, charge-discharge properties of the battery sintered body may be restrained from deteriorating.

Another aspect of any one of the first to third battery sintered bodies according to the present invention is characterized in that the above-mentioned solid electrolyte material is Li_{1.5}Al_{0.5}Ge_{1.5}(PO₄)₃.

According to this aspect, the battery sintered body, in which charge-discharge properties are restrained from deteriorating in accordance with sintering, may be obtained as described in the after-mentioned example.

A producing method of the first battery sintered body according to the present invention comprises steps of: an intermediate product preparing step of preparing an intermediate product containing one of an amorphous phosphate compound and a phosphate compound of a nasicon type as a solid electrolyte material and an oxide of a spinel type containing at least one of Ni and Mn as an active material, and a sintering step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method.

In the battery sintered body obtained by the first producing method, ions may move favorably. That is to say, the battery sintered body, in which charge-discharge properties are restrained from deteriorating, may be obtained by the first producing method.

An aspect of the producing method of the first battery sintered body according to the present invention further comprises a preliminary sintering step of obtaining the above-mentioned phosphate compound of a nasicon type as the above-mentioned solid electrolyte material by sintering the above-mentioned amorphous phosphate compound.

According to this aspect, the battery sintered body, in which charge-discharge properties are restrained from deteriorating in accordance with sintering, may be obtained as described in the after-mentioned example.

Another aspect of the producing method of the first battery sintered body according to the present invention is characterized in that a temperature of the above-mentioned sintering of the above-mentioned amorphous phosphate compound is higher than a crystallization temperature of the above-mentioned amorphous phosphate compound.

According to this aspect, the battery sintered body, in which charge-discharge properties are restrained from deteriorating in accordance with sintering, may be obtained as described in the after-mentioned example.

A producing method of the second battery sintered body according to the present invention comprises steps of: an intermediate product preparing step of preparing an intermediate product containing one of an amorphous phosphate compound and a phosphate compound of a nasicon type as a solid electrolyte material and LiCoO₂ as an active material, and a sintering step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method.

In the battery sintered body obtained by the second producing method, ions may move favorably. That is to say, the battery sintered body, in which charge-discharge properties are restrained from deteriorating, may be obtained by the second producing method.

A producing method of the third battery sintered body according to the present invention comprises steps of: an intermediate product preparing step of preparing an intermediate product containing one of an amorphous phosphate compound and a phosphate compound of a nasicon type as a solid electrolyte material and a transition metal oxide represented by the following general formula (2) as an active material, and a sintering step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method:

M2_{y1}O_{y2} (2)

(in the above-mentioned general formula (2), M2 is a transition metal element except Ti and has the largest possible valence, and y1 and y2 are 0≦y1 and 0≦y2).

In the battery sintered body obtained by the third producing method, ions may move favorably. That is to say, the battery sintered body, in which charge-discharge properties are restrained from deteriorating, may be obtained by the third producing method.

Another aspect of the third producing method according to the present invention is characterized in that the above-mentioned active material is Nb₂O₅.

Another aspect of the third producing method according to the present invention is characterized in that the above-mentioned active material is WO₃.

Yet another aspect of the third producing method according to the present invention is characterized in that the above-mentioned active material is MoO₃.

Still another aspect of the third producing method according to the present invention is characterized in that the above-mentioned active material is Ta₂O₅.

An all solid lithium battery according to the present invention comprises any one of the above-mentioned first to third battery sintered bodies.

The all solid lithium battery according to the present invention is excellent in output characteristics by reason of having the above-mentioned battery sintered body.

### Advantageous Effects of Invention

The present invention produces the effect such as to allow a battery sintered body, in which charge-discharge properties are restrained from deteriorating in accordance with sintering, to be provided.

### BRIEF DESCRIPTION OF DRAWINGS

FIG. 1 is a cross-sectional view conceptually showing an aspect of a first embodiment.

FIG. 2 is a cross-sectional view conceptually showing another aspect of the first embodiment.

FIGS. 3A and 3B are each a cross-sectional view conceptually showing an aspect of a fourth embodiment.

FIGS. 4A and 4B are each a cross-sectional view conceptually showing another aspect of the fourth embodiment.

FIG. 5 is a cross-sectional view conceptually showing an aspect of a seventh embodiment.

FIG. 6 is a TG/DTA curve of glassy Li_{1.5}Al_{0.5}Ge_{1.5}(PO₄)₃.

FIGS. 7A and 7B are each a result of XRD measurement of a battery sintered body obtained in each of Experimental Examples 1-7 and 1-3.

FIGS. 8A and 8B are each a result of XRD measurement of a battery sintered body obtained in each of Experimental Examples 2-7 and 2-3.

FIGS. 9A to 93 are each a result of XRD measurement of a battery sintered body obtained in each of Experimental Examples 3-1, 3-2, 3-3 and 3-4.

FIGS. 10A and 10B are each an example of a result of XRD measurement in a battery sintered body obtained in a second aspect of a third embodiment.

FIGS. 11A and 119 are each an example of a result of XRD measurement in a battery sintered body obtained in a third aspect of the third embodiment.

FIGS. 12A to 12C are each an example of a result of XRD measurement in a battery sintered body obtained in a fourth aspect of the third embodiment.

### DESCRIPTION OF EMBODIMENTS

A battery sintered body, a producing method of the battery sintered body and an all solid lithium battery of the present invention are hereinafter described in detail.

### A. Battery Sintered Body

### 1. First Embodiment

A first embodiment of the present invention is hereinafter described in detail.

A battery sintered body according to the first embodiment of the present invention comprises: a phosphate compound of a nasicon type as a solid electrolyte material and an oxide of a spinel type containing at least one of Ni and Mn as an active material, characterized in that a component except a component of the above-mentioned solid electrolyte material and a component of the above-mentioned active material is not detected on an interface between the above-mentioned solid electrolyte material and the above-mentioned active material in analyzing by an X-ray diffraction method.

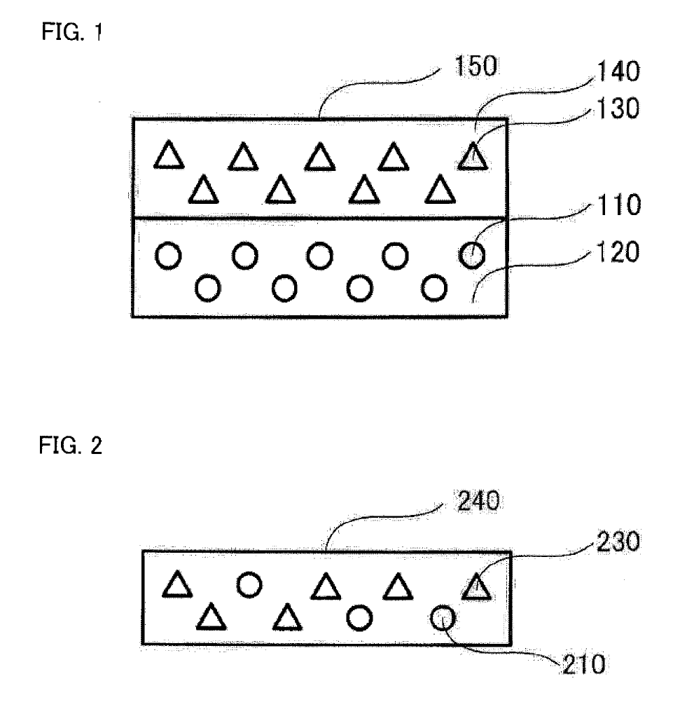

FIG. 1 is a cross-sectional view conceptually showing an aspect of the first embodiment. In FIG. 1, a laminated body 150 as a battery sintered body comprises a solid electrolyte layer 120 containing a solid electrolyte material 110 and an active material layer 140 containing an active material 130. FIG. 2 is a cross-sectional view conceptually showing another aspect of the first embodiment. In FIG. 2, an active material layer 240 as a battery sintered body contains a solid electrolyte material 210 and an active material 230, which are in a mixed state.

According to the first embodiment, the use by combination of a phosphate compound of a nasicon type and an oxide of a spinel type containing at least one of Ni and Mn allows the battery sintered body, in which a component except a component of the phosphate compound of a nasicon type and a component of the oxide of a spinel type containing at least one of Ni and Mn is not detected on an interface between the phosphate compound of a nasicon type and the oxide of a spinel type containing at least one of Ni and Mn in analyzing by an X-ray diffraction method. That is to say, the battery sintered body having no heterogenous phases on the above-mentioned interface may be obtained. Incidentally, the heterogenous phase signifies a compound having a crystal structure different from a solid electrolyte material and an active material. Specific examples thereof include a decomposed product of the solid electrolyte material, a decomposed product of the active material, and a reaction product of the solid electrolyte material and the active material.

In such a battery sintered body, ions may move favorably for the reason that the heterogenous phase does not exist. Thus, charge-discharge properties of the battery sintered body may be restrained from deteriorating. Also, the use by combination of a phosphate compound of a nasicon type and an oxide of a spinel type containing at least one of Ni and Mn allows sintering at lower temperature than sintering temperature of a sintered body for existing various batteries.

Also, the battery sintered body according to the first embodiment is greatly characterized in that a component except a component of the above-mentioned solid electrolyte material and a component of the above-mentioned active material is not detected on an interface between the above-mentioned solid electrolyte material and the above-mentioned active material in analyzing by an X-ray diffraction (XRD) method. Specifically, XRD measurement is performed for the battery sintered body to identify an obtained peak.

The same X-ray diffraction method as existing various X-ray diffraction methods may be used for the X-ray diffraction method. Examples thereof include a method using a CuKα ray. Also, for example, RINT UltimaIII™ manufactured by Rigaku Corporation may be used for XRD measurement.

(1) Solid Electrolyte Material

The solid electrolyte material in the first embodiment is a phosphate compound of a nasicon type. Here, the nasicon type signifies a type having a crystal structure of a nasicon type. In addition, “having a crystal structure of a nasicon type” signifies not completely being amorphous, and includes not merely being completely crystalline but also an intermediate state between being amorphous and crystalline. That is to say, a phosphate compound of a nasicon type may have crystallinity such that a peak may be confirmed by an X-ray diffraction method.

The above-mentioned solid electrolyte material is not particularly limited if the solid electrolyte material is a phosphate compound of a nasicon type, but is preferably, for example, a phosphate compound of a nasicon type represented by the general formula (3) of Li_{1+z}M3_{z}M4_{2-z}(PO₄)₃ (in the above-mentioned general formula (3), M3 is at least one kind selected from the group consisting of Al, Y, Ga and In, M4 is at least one kind selected from the group consisting of Ti, Ge and Zr, and “z” is 0≦z≦2).

The above-mentioned metal of M3 is preferably at least one kind selected from the group consisting of Al, Y and Ga among the above, preferably Al above all. In addition, the above-mentioned metal of M4 is preferably at least one kind selected from the group consisting of Ge and Ti among the above, preferably Ge above all. Furthermore, it is preferable that the metal of M3 is Al and the metal of M4 is Ge. Also, the above-mentioned range of “z” is preferably 0.1≦z≦1.9, more preferably 0.3≦z≦0.7 among the above. In particular, the solid electrolyte material is preferably Li_{1.5}Al_{0.5}Ge_{1.5}(PO₄)₃ in the above-mentioned general formula.

The shape of the solid electrolyte material before sintering is powdery for example, and the average particle diameter thereof is preferably within a range of 0.1 μm to 5.0 μm, more preferably within a range of 0.1 μm to 2.0 μm. The reason therefor is that too large average particle diameter brings a possibility of obtaining a minute battery sintered body with difficulty, while too small average particle diameter brings a possibility of producing the solid electrolyte material with difficulty. Incidentally, the above-mentioned average particle diameter may be defined by D₅₀ measured with a particle size distributor. Also, the average particle diameter of each of the after-mentioned materials may be defined similarly.

(2) Active Material

The active material in the first embodiment is an oxide of a spinel type containing at least one of Ni and Mn. Here, the spinal type signifies a type having a crystal structure of a spinel type. The above-mentioned active material is ordinarily high in crystallinity and is preferably crystalline.

The above-mentioned active material is not particularly limited if the active material is the above-mentioned oxide of a spinal type, but is preferably, for example, an oxide of a spinel type containing at least Mn represented by the general formula (1) of LiM1ₓMn₂₋ₓO₄ (in the above-mentioned general formula (1), M1 is at least one kind selected from the group consisting of Cr, Fe, Co, Ni and Cu, and “x” is 0≦x<2). The reason therefor is that the inclusion of Mn allows performance as the active material to be improved.

The above-mentioned metal of M1 is preferably at least one kind selected from the group consisting of Ni, Co and Fe among the above, preferably Ni above all. The above-mentioned range of “x” is preferably 0≦x≦1.5, more preferably 0≦x≦1.0 among the above. In particular, the active material is preferably LiNi_{0.5}Mn_{1.5}O₄ in the above-mentioned general formula (1). Also, the active material in the first embodiment is preferably used as a cathode active material.

The shape of the active material before sintering is powdery for example, and the average particle diameter thereof is preferably within a range of 1 μm to 10 μm, more preferably within a range of 2 μm to 6 μm. The reason therefor is that too large average particle diameter brings a possibility of obtaining a minute battery sintered body with difficulty, while too small average particle diameter brings a possibility of producing the active material with difficulty.

(3) Battery Sintered Body

The battery sintered body according to the first embodiment signifies a body containing the solid electrolyte material and the active material obtained by sintering, which is used for a battery. Here, sintering signifies a phenomenon such that an aggregate of solid powder hardens by heating into a minute body. The battery sintered body is not particularly limited if the battery sintered body is a sintered body used as a member of a battery. Here, a sintered body signifies a minute body hardened by heating an aggregate of solid powder.

Examples of a structure of the battery sintered body comprise the laminated body 150 including the solid electrolyte layer 120 and the active material layer 140, as shown in the above-mentioned FIG. 1. In this aspect, ordinarily, the solid electrolyte layer contains the above-mentioned solid electrolyte material and the active material layer contains the above-mentioned active material. In this case, the above-mentioned interface is a boundary surface on which the solid electrolyte layer containing the solid electrolyte material contacts with the active material layer containing the active material. Also, the solid electrolyte layer 120 and the active material layer 140 are ordinarily integrated mutually by sintering.

The content of the above-mentioned solid electrolyte material in the solid electrolyte layer of the laminated body is not particularly limited, but is preferably larger from the viewpoint of restraining a heterogenous phase from occurring; specifically, preferably 1% by volume or more, more preferably 10% by volume or more. Incidentally, the solid electrolyte layer may be a layer consisting essentially of the above-mentioned solid electrolyte material. The thickness of the above-mentioned solid electrolyte layer is not particularly limited, but is, for example, preferably within a range of 1 μm to 0.1 mm, and more preferably within a range of 2 μm to 0.05 mm. The voidage of the above-mentioned solid electrolyte layer varies with kinds of the solid electrolyte material to be used, but is, for example, preferably 20% or less, and more preferably 10% or less.

On the other hand, the content of the above-mentioned active material in the active material layer of the laminated body is not particularly limited, but is, for example, preferably within a range of 50% by volume to 90% by volume, and more preferably within a range of 70% by volume to 90% by volume. Incidentally, the active material layer may be a layer consisting essentially of the above-mentioned active material. The thickness of the above-mentioned active material layer is not particularly limited, but is, for example, preferably within a range of 5 μm to 0.1 mm, and more preferably within a range of 10 μm to 0.05 mm. The voidage of the above-mentioned active material layer varies with kinds of the active material to be used, but is, for example, preferably 15% or less, and more preferably within a range of 5% to 10%. Also, the above-mentioned active material layer may further contain the above-mentioned solid electrolyte material. In the case where the battery sintered body is a laminated body, the laminated body may have the active material layer on one surface of the solid electrolyte layer, or the active material layer (a cathode active material layer and an anode active material layer) on each of both surfaces of the solid electrolyte layer. In the case of the latter, the battery sintered body may be directly regarded as a power generating element of a battery.

Other examples of a structure of the battery sintered body include the active material layer 240, as shown in the above-mentioned FIG. 2. In this aspect, ordinarily, the active material layer contains both the above-mentioned solid electrolyte material and active material. In this case, the above-mentioned interface is a boundary surface on which the solid electrolyte material contacts with the active material. With regard to the ratio of the above-mentioned active material and the above-mentioned solid electrolyte material in the active material layer, the solid electrolyte material is preferably within a range of 10 parts by weight to 110 parts by weight, and more preferably within a range of 15 parts by weight to 50 parts by weight in the case of regarding the active material as 100 parts by weight. The reason therefor is that too small ratio of the solid electrolyte material brings a possibility of deteriorating ion conductivity of the active material layer, while too large ratio of the solid electrolyte material brings a possibility of decreasing capacity of the active material layer. Incidentally, the content of the active material in the active material layer, and thickness and voidage of the active material layer are the same as the above-mentioned contents.

Also, the battery sintered body may be a pellet-like shape or a sheet-like shape. The same shape as existing various sintered bodies may be used for the shape of the battery sintered body. Examples thereof include a columnar shape, a flat board shape and a cylindrical shape.

In presuming the mechanism of the battery sintered body according to the first embodiment of the present invention, which is constituted as described above, the element of the active material is incorporated into the crystal structure of the solid electrolyte material during sintering thereof. Alternatively, the element of the solid electrolyte material is incorporated into the crystal structure of the active material. That is to say, it is conceived that the element of the solid electrolyte material is substituted with the element of the active material. In other words, it is conceived that such substitution is caused by selecting a combination of a phosphate compound of a nasicon type and an oxide of a spinel type containing at least one of Ni and Mn.

The crystal structure of the solid electrolyte material and the active material does not change by such substitution. Thus, a component except a component of the solid electrolyte material and a component of the active material is not detected on an interface between the solid electrolyte material and the active material in analyzing by an X-ray diffraction method. In other words, a heterogenous phase is not detected on an interface between the solid electrolyte material and the active material in analyzing by an X-ray diffraction method.

Ions may move favorably for the reason that a heterogenous phase is not detected on an interface between the solid electrolyte material and the active material of the battery sintered body in analyzing by an X-ray diffraction method. Thus, charge-discharge properties of the battery sintered body may be restrained from deteriorating.

### 2. Second Embodiment

A second embodiment of the present invention is hereinafter described in detail.

A battery sintered body according to the second embodiment of the present invention comprises: a phosphate compound of a nasicon type as a solid electrolyte material; and LiCoO₂ as an active material, characterized in that a component except a component of the above-mentioned solid electrolyte material and a component of the above-mentioned active material is not detected on an interface between the above-mentioned solid electrolyte material and the above-mentioned active material in analyzing by an X-ray diffraction method.

According to the second embodiment, the use by combination of a phosphate compound of a nasicon type and LiCoO₂ allows the battery sintered body, in which a component except a component of the phosphate compound of a nasicon type and a component of LiCoO₂ is not detected on an interface between the phosphate compound of a nasicon type and LiCoO₂ in analyzing by an X-ray diffraction method. That is to say, the battery sintered body having no heterogenous phases on the above-mentioned interface may be obtained.

In such a battery sintered body, ions may move favorably for the reason that the heterogenous phase does not exist. Thus, charge-discharge properties of the battery sintered body may be restrained from deteriorating. Also, the use by combination of a phosphate compound of a nasicon type and LiCoO₂ allows sintering at lower temperature than sintering temperature of a sintered body for existing various batteries. Incidentally, the analysis by an X-ray diffraction method is the same as the contents described in the above-mentioned first embodiment.

(1) Solid Electrolyte Material

The solid electrolyte material in the second embodiment is the same as the contents described in the above-mentioned first embodiment; therefore, the description herein is omitted.

(2) Active Material

The active material in the second embodiment is LiCoO₂. LiCoO₂ is ordinarily high in crystallinity and is preferably crystalline. Also, the active material (LiCoO₂) in the second embodiment is preferably used as a cathode active material. The shape of LiCoO₂ before sintering is powdery for example, and the average particle diameter thereof is preferably within a range of 1 μm to 12 μm, and more preferably within a range of 2 μm to 6 μm. The reason therefor is that too large average particle diameter brings a possibility of obtaining a minute battery sintered body with difficulty, while too small average particle diameter brings a possibility of producing the active material with difficulty.

(3) Battery Sintered Body

The battery sintered body of the second embodiment is the same as the contents described in the above-mentioned first embodiment except for using LiCoO₂ as the active material; therefore, the description herein is omitted.

In presuming the mechanism of the battery sintered body according to the second embodiment of the present invention, which is constituted as described above, it is conceived that the crystal structure of a phosphate compound of a nasicon type and LiCoO₂ does not change during sintering thereof. Thus, a component except a component of a phosphate compound of a nasicon type and a component of LiCoO₂ is not detected on an interface between a phosphate compound of a nasicon type and LiCoO₂ in analyzing by an X-ray diffraction method. In other words, a heterogenous phase is not detected on an interface between a phosphate compound of a nasicon type and LiCoO₂ in analyzing by an X-ray diffraction method.

Ions may move favorably for the reason that a heterogenous phase is not detected on an interface between a phosphate compound of a nasicon type and LiCoO₂ of the battery sintered body in analyzing by an X-ray diffraction method. Thus, charge-discharge properties of the battery sintered body may be restrained from deteriorating.

### 3. Third Embodiment

A third embodiment of the present invention is hereinafter described in detail.

A battery sintered body according to the third embodiment of the present invention comprises: a phosphate compound of a nasicon type as a solid electrolyte material; and a transition metal oxide represented by the following general formula (2) as an active material, characterized in that a component except a component of the above-mentioned solid electrolyte material and a component of the above-mentioned active material is not detected on an interface between the above-mentioned solid electrolyte material and the above-mentioned active material in analyzing by an X-ray diffraction method:

M2_{y1}O_{y2} (2)

(in the above-mentioned general formula (2), M2 is a transition metal element except Ti and has the largest possible valence, and y1 and y2 are 0≦y1 and 0≦y2).

According to the third embodiment, the use by combination of a phosphate compound of a nasicon type and a transition metal oxide allows the battery sintered body, in which a component except a component of the phosphate compound of a nasicon type and a component of the transition metal oxide is not detected on an interface between the phosphate compound of a nasicon type and the transition metal oxide in analyzing by an X-ray diffraction method. That is to say, the battery sintered body having no heterogenous phases on the above-mentioned interface may be obtained. Also, as described later, the above-mentioned transition metal oxide has the advantage that volume theoretical capacity is large.

In such a battery sintered body, ions may move favorably for the reason that the heterogenous phase does not exist. Thus, charge-discharge properties of the battery sintered body may be restrained from deteriorating. Incidentally, the analysis by an X-ray diffraction method is the same as the contents described in the above-mentioned first embodiment.

(1) Solid Electrolyte Material

The solid electrolyte material in the third embodiment is the same as the contents described in the above-mentioned first embodiment; therefore, the description herein is omitted.

(2) Active Material

The active material in the third embodiment is a transition metal oxide represented by the general formula (2) of M2_{y1}O_{y2}. Also, in the above-mentioned general formula (2), M2 is a transition metal element except Ti and has the largest possible valence, and y1 and y2 are 0≦y1 and 0≦y2.

Here, the reason why the heterogenous phase does not occur on the above-mentioned interface has not been clear yet but the following mechanism is presumed. That is to say, it is conceived that the above-mentioned transition metal oxide does not reduce the solid electrolyte material (the transition metal oxide itself is not oxidized) by reason of having the largest possible valence when contacting with the solid electrolyte material. Thus, it is conceived that the solid electrolyte material is not decomposed by a reduction reaction and the heterogenous phase is not produced. Accordingly, the battery sintered body with favorable ion conduction may be obtained and charge-discharge properties may be restrained from deteriorating.

On the other hand, in Non Patent Literature 1, an all solid state battery of a laminate sintering type is disclosed which uses TiO₂ as an anode active material. TiO₂ is a transition metal oxide which satisfies the above-mentioned general formula (2), and Ti as a transition metal element is in a state of having the largest possible valence. Also, it is confirmed that the heterogenous phase is not produced after sintering in the anode using TiO₂. However, in Non Patent Literature 1, neither description nor suggestion is offered on a mechanism such that the heterogenous phase is not produced by a combination of TiO₂ and a solid electrolyte material.

Then, the inventors of the present invention have completed the battery sintered body of this embodiment by studying a heterogenous phase production mechanism when the transition metal oxide represented by the above-mentioned general formula (2) contacts with the solid electrolyte material.

M2 used for this embodiment is not particularly limited if M2 is a transition metal element except Ti. In addition, a general transition metal element may exhibit diverse oxidation states by having one or plural valences, and the above-mentioned M2 has the largest possible valence. Here, the above-mentioned “the largest possible valence” signifies the largest valence among valences in a state in which each transition metal element exists stably in a compound. Thus, in the present invention, a peroxide is not included as a compound in which the above-mentioned transition metal element exists stably.

Specifically, the largest possible valence of each transition metal element is as follows. That is to say, examples of a transition metal element with the largest valence of +6 include Mo, W, Cr and Re, and examples of a transition metal element with the largest valence of +5 include Nb, Ta and V. Also, examples of a transition metal element with the largest valence of +4 include Ti, Mn, Zr, To, Ru, Pd, Ce, Hf, Os, Ir and Pt, and examples of a transition metal element with the largest valence of +3 include Sc, Fe, Co, Y, Rh, La, Pr, Nd, Sm, Eu, Gd, Tb, Dy, Tm, Yb and Au. In addition, examples of a transition metal element with the largest valence of +2 include Ni, Cu, Zn and Cd, and examples of a transition metal element with the largest valence of +1 include Ag.

The largest valence of M2 used for this embodiment is not particularly limited if the largest valence is a possible valence of a general transition metal element, but examples thereof include +3, +4, +5 and +6. Above all, +5 or larger is preferable and +6 or larger is preferable.

Examples of a transition metal element used as the above-mentioned M2 include Mo, W, Cr, Re, Nb, Ta, V, Mn, Zr, Tc, Ru, Pd, Ce, Hf, Os, Ir, Pt, Sc, Fe, Co, Y, Rh, La, Pr, Nd, Sm, Eu, Gd, Tb, Dy, Tm, Yb and Au; above all, Nb, Ta, V, W, Mo, Cr and Re may be used appropriately.

Specifically, in the case where the transition metal element is Nb, a possible valence of Nb is +5, +4, +3, +2, 0 and −1, and the above-mentioned “the largest possible valence of the transition metal element” is +5. Accordingly, specific examples of the transition metal oxide such that a valence of Nb is +5 include Nb₂O₅. Also, in the case where the transition metal element is W, a possible valence of W is +6, +5, +4, +3, +2, +1 and 0, and the above-mentioned largest valence is +6. Accordingly, specific examples of the transition metal oxide such that a valence of W is +6 include NO₃. In addition, in the case where the transition metal element is Mo, a possible valence of Mo is +6, +5, +4, +3, +2, +1, 0, −1 and −2, and the above-mentioned largest valence is +6. Accordingly, specific examples of the transition metal oxide such that a valence of No is +6 include MoO₃. Also, in the case where the transition metal element is Ta, a possible valence of Ta is +5, +4, +3 and +2, and the above-mentioned largest valence is +5. Accordingly, specific examples of the transition metal oxide such that a valence of Ta is +5 include Ta₂O₅.

Also, in the case where M2 in the present invention is the above-mentioned transition metal element, the transition metal oxide represented by the general formula (2) of M2_{y1}O_{y2} is, for example, preferably y₂/y₁≧2.5 or more, and more preferably y₂/y₁≧3.0 or more. The reason therefor is to allow the effect of the present invention to be performed more easily.

The battery sintered body of the third embodiment may be classified into four preferable aspects in accordance with kinds of the active material. Specifically, the aspects are an aspect such that the active material is Nb₂O₅ (a first aspect), an aspect such that the active material is NO₃ (a second aspect), an aspect such that the active material is MoO₃ (a third aspect), and an aspect such that the active material is Ta₂O₅ (a fourth aspect).

The battery sintered body of the third embodiment is hereinafter described in detail while classified into each of the aspects.

(i) First Aspect

The first aspect of the active material in the third embodiment is described. The active material of this aspect is Nb₂O₅.

Nb₂O₅ as the active material is combined with the above-mentioned phosphate compound of a nasicon type to form the sintered body, so that the heterogenous phase is not formed and ions may move favorably in the sintered body. Thus, charge-discharge properties of the battery sintered body may be restrained from deteriorating. Also, with regard to the sintered body of this aspect, the use of Nb₂O₅ as the active material allows the sintered body capable of charge and discharge for the reason that sintering proceeds without producing the heterogenous phase on an interface between the active material and the solid electrolyte material even in sintering at sintering temperature of a sintered body for existing various batteries. Thus, process costs may be decreased.

Nb₂O₅ in this aspect is ordinarily high in crystallinity and is preferably crystalline. Also, the active material (Nb₂O₅) in this aspect may be used as a cathode active material or as an anode active material, and is preferably used as an anode active material above all. Examples of the shape of Nb₂O₅ before sintering include a powdery shape. Also, the average particle diameter thereof is, for example, preferably within a range of 0.1 μm to 20 μm, and more preferably within a range of 0.1 μm to 2 μm. The reason therefor is that too large average particle diameter brings a possibility of obtaining a minute battery sintered body with difficulty, while too small average particle diameter brings a possibility of producing the active material with difficulty.

(ii) Second Aspect

The second aspect of the active material in the third embodiment is described. The active material of this aspect is characterized by being WO₃.

WO₃ used as the active material in this aspect is large in volume theoretical capacity in comparison with a conventionally general anode active material for a battery. For example, the advantage is that volume capacity density is large as compared with carbon and Li₄Ti₅O₁₂ as a general anode active material for a battery. Also, the use of WO₃ as the active material allows the sintered body capable of charge and discharge for the reason that sintering proceeds without producing the heterogenous phase on an interface between the active material and the solid electrolyte material even in sintering at sintering temperature of a sintered body for the above-mentioned existing various batteries, and allows the sintered body capable of charge and discharge similarly even in sintering at lower temperature than sintering temperature of a sintered body for the above-mentioned existing various batteries.

WO₃ in this aspect is ordinarily high in crystallinity and is preferably crystalline. Also, the active material (WO₃) in this aspect may be used as a cathode active material or as an anode active material. Examples of the shape of WO₃ before sintering include a powdery shape. Also, the average particle diameter thereof is, for example, preferably within a range of 0.1 μm to 20 μm, and more preferably within a range of 0.1 μm to 2 μm. The reason therefor is that too large average particle diameter brings a possibility of obtaining a minute battery sintered body with difficulty, while too small average particle diameter brings a possibility of producing the active material with difficulty.

(iii) Third Aspect

The third aspect of the active material in the third embodiment is described. The active material of this aspect is characterized by being MoO₃.

MoO₃ used as the active material in this aspect is large in volume theoretical capacity in comparison with a conventionally general anode active material for a battery. The advantage is that volume capacity density is large as compared with carbon and Li₄Ti₅O₁₂ as a general anode active material for a battery, similarly to the above-mentioned second aspect. Also, the use of MoO₃ as the active material allows the sintered body capable of charge and discharge for the reason that sintering proceeds without producing the heterogenous phase on an interface between the active material and the solid electrolyte material even in sintering at sintering temperature of a sintered body for the above-mentioned existing various batteries, and allows the sintered body capable of charge and discharge similarly even in sintering at lower temperature than sintering temperature of a sintered body for the above-mentioned existing various batteries. Also, MoO₃ as the active material may exhibit high electric potential as compared with an active material used for a lithium secondary battery of a general coin type for a memory backup, such as LiMn₂O₄, Nb₂O₅ and Li₄Ti₅O₁₂.

MoO₃ in this aspect is ordinarily high in crystallinity and is preferably crystalline. Also, the active material (MoO₃) in this aspect may be used as a cathode active material or as an anode active material. Examples of the shape of MoO₃ before sintering include a powdery shape. Also, the average particle diameter thereof is, for example, preferably within a range of 0.1 μm to 20 μm, and more preferably within a range of 0.1 μm to 2 μm. The reason therefor is that too large average particle diameter brings a possibility of obtaining a minute battery sintered body with difficulty, while too small average particle diameter brings a possibility of producing the active material with difficulty.

(iv) Fourth Aspect

The fourth aspect of the active material in the third embodiment is described. The active material of this aspect is characterized by being Ta₂O₅.

Ta₂O₅ used as the active material in this aspect is large in volume theoretical capacity in comparison with a conventionally general anode active material for a battery. The advantage is that volume capacity density is large as compared with carbon and Li₄Ti₅O₁₂ as a general anode active material for a battery, similarly to the above-mentioned second aspect. Also, the use of Ta₂O₅ as the active material allows the sintered body capable of charge and discharge for the reason that sintering proceeds without producing the heterogenous phase on an interface between the active material and the solid electrolyte material even in sintering at sintering temperature of a sintered body for the above-mentioned existing various batteries, and allows the sintered body capable of charge and discharge similarly even in sintering at lower temperature than sintering temperature of a sintered body for the above-mentioned existing various batteries.

Ta₂O₅ in this aspect is ordinarily high in crystallinity and is preferably crystalline. Also, the active material (Ta₂O₅) in this aspect may be used as a cathode active material or as an anode active material. Examples of the shape of Ta₂O₅ before sintering include a powdery shape. Also, the average particle diameter thereof is, for example, preferably within a range of 0.1 μm to 20 μm, and more preferably within a range of 0.1 μm to 2 μm. The reason therefor is that too large average particle diameter brings a possibility of obtaining a minute battery sintered body with difficulty, while too small average particle diameter brings a possibility of producing the active material with difficulty.

(3) Battery Sintered Body

The battery sintered body of this aspect is the same as the contents described in the above-mentioned first embodiment except for using the above-mentioned transition metal oxide as the active material; therefore, the description herein is omitted.

In presuming the mechanism of the battery sintered body according to the third embodiment of the present invention, which is constituted as described above, it is conceived that the crystal structure of a phosphate compound of a nasicon type and a transition metal oxide does not change during sintering thereof. Thus, a component except a component of a phosphate compound of a nasicon type and a component of a transition metal oxide is not detected on an interface between a phosphate compound of a nasicon type and a transition metal oxide in analyzing by an X-ray diffraction method. In other words, a heterogenous phase is not detected on an interface between a phosphate compound of a nasicon type and a transition metal oxide in analyzing by an X-ray diffraction method.

Ions may move favorably for the reason that a heterogenous phase is not detected on an interface between a phosphate compound of a nasicon type and a transition metal oxide of the battery sintered body in analyzing by an X-ray diffraction method. Thus, charge-discharge properties of the battery sintered body may be restrained from deteriorating.

### B. Producing Method of Battery Sintered Body

### 1. Fourth Embodiment

A fourth embodiment of the present invention is hereinafter described in detail.

A producing method of a battery sintered body according to the fourth embodiment of the present invention comprises steps of: an intermediate product preparing step of preparing an intermediate product containing one of an amorphous phosphate compound and a phosphate compound of a nasicon type as a solid electrolyte material and an oxide of a spinel type containing at least one of Ni and Mn as an active material, and a sintering step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method.

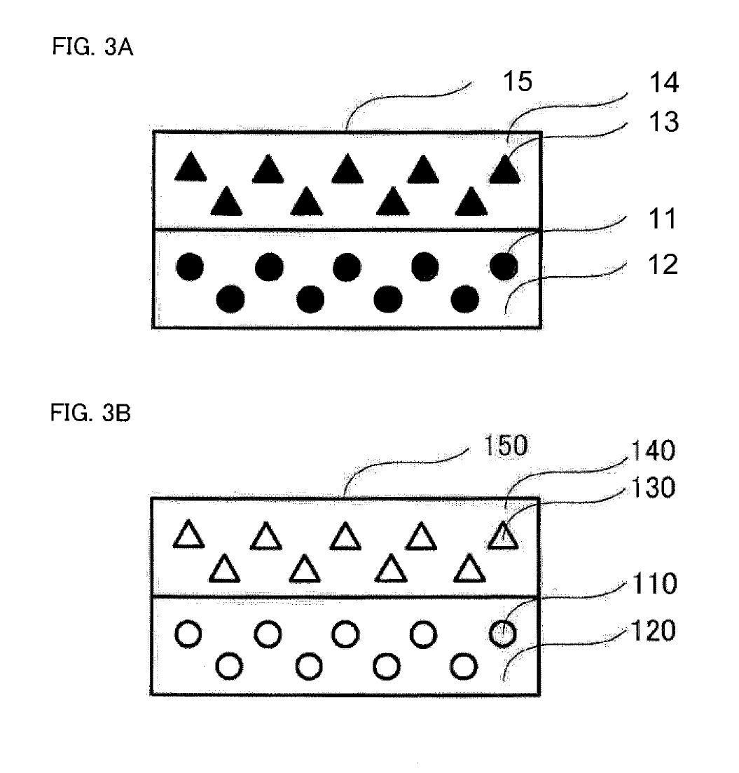

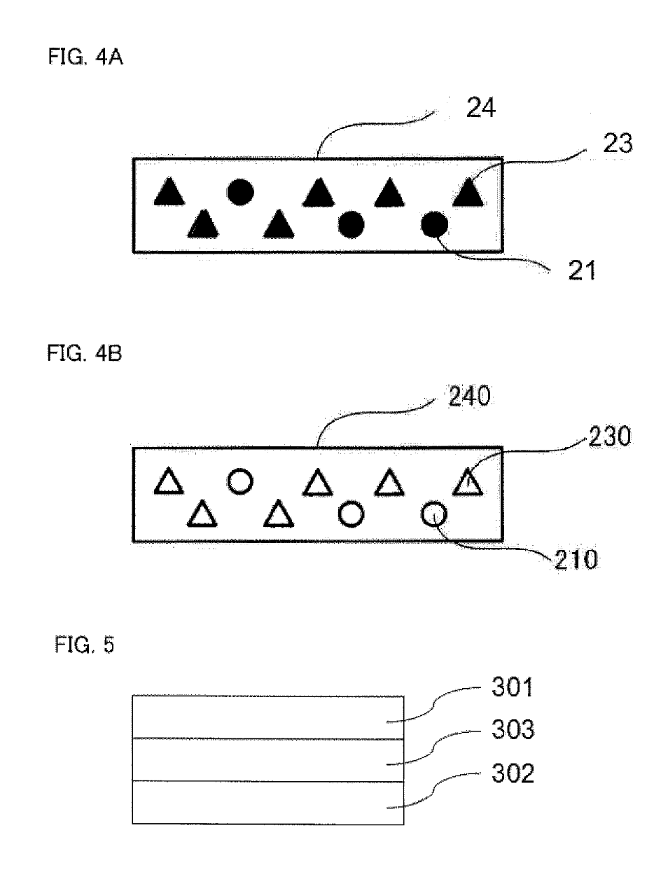

FIGS. 3A and 3B are each a cross-sectional view conceptually showing an aspect of the fourth embodiment. In FIGS. 3A and 33, first, a laminated body 15 an intermediate product) including a solid electrolyte layer 12 containing a solid electrolyte material 11 and an active material layer 14 containing an active material 13 is prepared (FIG. 3A). Thereafter, a laminated body 150 as a battery sintered body may be obtained by sintering the laminated body 15 at a predetermined temperature (FIG. 3B). FIGS. 4A and 48 are each a cross-sectional view conceptually showing another aspect of the fourth embodiment. In FIGS. 4A and 4B, first, an active material layer 24 (an intermediate product) containing a solid electrolyte material 21 and an active material 23 is prepared (FIG. 4A). Thereafter, an active material layer 240 as a battery sintered body may be obtained by sintering the active material layer 24 at a predetermined temperature (FIG. 4B).

According to the fourth embodiment, the production by combination of one of an amorphous phosphate compound and a phosphate compound of a nasicon type and an oxide of a spinel type containing at least one of Ni and Mn allows the battery sintered body, in which a component except a component of the phosphate compound of a nasicon type and a component of the oxide of a spinel type containing at least one of Ni and Mn is not detected on an interface between the phosphate compound of a nasicon type and the oxide of a spinel type containing at least one of Ni and Mn in analyzing by an X-ray diffraction method. That is to say, the battery sintered body having no heterogenous phases on the above-mentioned interface may be obtained. Incidentally, the heterogenous phase signifies a compound having a crystal structure different from a solid electrolyte material and an active material.

In the battery sintered body obtained by the producing method of the battery sintered body according to the fourth embodiment, ions may move favorably for the reason that the heterogenous phase does not exist. That is to say, the battery sintered body, in which charge-discharge properties are restrained from deteriorating, may be obtained by the producing method of the battery sintered body according to the fourth embodiment. Also, the production by combination of one of an amorphous phosphate compound and a phosphate compound of a nasicon type and an oxide of a spinel type containing at least one of Ni and Mn allows sintering at lower temperature than sintering temperature of a sintered body for existing various batteries.

Also, the producing method of the battery sintered body according to the fourth embodiment is greatly characterized in that the above-mentioned intermediate product is sintered at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method. Specifically, XRD measurement is performed for the obtained battery sintered body to identify an obtained peak and determine sintering temperature.

The same X-ray diffraction method as existing various X-ray diffraction methods may be used for the X-ray diffraction method. Examples thereof include a method using a CuKα ray. Also, for example, RINT UltimaIII™ manufactured by Rigaku Corporation may be used for XRD measurement.

The producing method of the battery sintered body according to the fourth embodiment of the present invention is hereinafter described in each step.

(1) Intermediate Product Preparing Step

The intermediate product preparing step in the fourth embodiment is a step of preparing an intermediate product containing one of an amorphous phosphate compound and a phosphate compound of a nasicon type as a solid electrolyte material and an oxide of a spinel type containing at least one of Ni and Mn as an active material.

The composition and shape of the solid electrolyte material contained in the intermediate product are the same as the contents described in the above-mentioned first embodiment. In the fourth embodiment, not merely a phosphate compound of a nasicon type but also an amorphous phosphate compound may be used as the solid electrolyte material contained in the intermediate product. In particular, the solid electrolyte material contained in the intermediate product is preferably Li_{1.5}Al_{0.5}Ge_{1.5}(PO₄)₃

In order to obtain a solid electrolyte material with high crystallinity, the fourth embodiment may further comprises a preliminary sintering step of obtaining the above-mentioned phosphate compound of a nasicon type as the above-mentioned solid electrolyte material by sintering the amorphous phosphate compound. Here, “sintering the amorphous phosphate compound” signifies heat treatment for improving crystallinity of the amorphous phosphate compound. The sintering temperature of the amorphous phosphate compound is not particularly limited if the sintering temperature is a temperature such as to allow crystallinity, but is preferably higher than a crystallization temperature of the amorphous phosphate compound. The reason therefor is that the effect such that a component except a component of the solid electrolyte material and a component of the active material is not detected is performed more easily. That is to say, the solid electrolyte material contained in the intermediate product is preferably heat-treated at a temperature of the crystallization temperature or higher.

As described in the after-mentioned examples, the crystallization temperature of Li_{1.5}Al_{0.5}Ge_{1.5}(PO₄)₃ as the solid electrolyte material is 630° C. Thus, with regard to the solid electrolyte material heat-treated at a temperature of 630° C. or higher, the effect such that a component except a component of the solid electrolyte material and a component of the active material is not detected is performed more easily. On the other hand, as described in the after-mentioned examples, in the case where the solid electrolyte material is Li_{1.5}Al_{0.5}Ge_{1.5}(PO₄)₃ and the active material is LiNi_{0.5}Mn_{1.5}O₄, the battery sintered body, in which a component except a component of the solid electrolyte material and a component of the active material is not detected, may be produced by sintering in a range of 500° C. to 550° C. in the sintering step even though the sintering temperature of the amorphous Li_{1.5}Al_{0.5}Ge_{1.5}(PO₄)₃ in preliminary sintering step is lower temperature than a crystallization temperature thereof.

The composition and shape of the active material contained in the intermediate product are the same as the contents described in the above-mentioned first embodiment. In particular, the active material contained in the intermediate product is preferably LiNi_{0.5}Mn_{1.5}O₄.

The structure of the intermediate product varies in accordance with the structure of the intended battery sintered body. For example, as FIG. 3B, in the case of obtaining the battery sintered body as the laminated body, the intermediate product of the laminated body is prepared. Each of the solid electrolyte layer and the active material layer composing the intermediate product is preferably in a pelletized form. Also, a powdery material for forming the solid electrolyte layer and a powdery material for forming the active material layer may be pelletized simultaneously. On the other hand, as FIG. 4B, in the case of obtaining the battery sintered body as the active material layer, the intermediate product of the active material layer is prepared. The active material layer composing the intermediate product is preferably in a pelletized form.

(2) Sintering Step

The sintering step in the fourth embodiment is a step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method.

The sintering temperature for sintering the intermediate product is not particularly limited if the sintering temperature is a temperature such that a component except a component of the above-mentioned solid electrolyte material and a component of the above-mentioned active material is not detected, but is preferably lower. The reason therefor is that process costs may be decreased. In particular, the above-mentioned sintering temperature is preferably less than 700° C. The reason therefor is that when less than 700° C., a special electric furnace is not required and a soaking zone in the furnace may be widely secured, and consequently heat is uniformly conducted easily through a test sample. In particular, in the case where the solid electrolyte material is Li_{1.5}Al_{0.5}Ge_{1.5}(PO₄)₃ and the active material is LiNi_{0.5}Mn_{1.5}O₄, the sintering temperature is, for example, preferably within a range of 450° C. to 650° C., and more preferably within a range of 500° C. to 600° C. Incidentally, too low sintering temperature for sintering the intermediate product brings a possibility that sintering does not proceed sufficiently. Whether sintering proceeds sufficiently or not may be determined by whether a component of the sintered body is transferred or not when Sellotape (registered trademark) is stuck on and peeled off the surface of the sintered body, for example. When a component of the sintered body is transferred to peeled Sellotape (registered trademark), it may be determined that sintering does not proceed sufficiently. Also, whether sintering proceeds sufficiently or not may be determined by whether a member after burning has density (filling factor, voidage) unattainable in powder compacting treatment or not.

Also, the sintering time for sintering the intermediate product is not particularly limited if the sintering time is such as to allow a desired battery sintered body. Examples of a method of sintering the intermediate product include a method using a burning furnace. Examples of an atmosphere during sintering include an air atmosphere and an inert atmosphere, preferably an inert atmosphere. The reason therefor is to allow an unnecessary oxidation reaction to be prevented. Examples of the inert atmosphere include an argon atmosphere and a nitrogen atmosphere.

### 2. Fifth Embodiment

A fifth embodiment of the present invention is hereinafter described in detail.

A producing method of a battery sintered body according to the fifth embodiment of the present invention comprises steps of: an intermediate product preparing step of preparing an intermediate product containing one of an amorphous phosphate compound and a phosphate compound of a nasicon type as a solid electrolyte material and LiCoO₂ as an active material, and a sintering step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method.

According to the fifth embodiment, the production by combination of one of an amorphous phosphate compound and a phosphate compound of a nasicon type and LiCoO₂ allows the battery sintered body, in which a component except a component of the phosphate compound of a nasicon type and a component of LiCoO₂ is not detected on an interface between the phosphate compound of a nasicon type and LiCoO₂ in analyzing by an X-ray diffraction method. That is to say, the battery sintered body having no heterogenous phases on the above-mentioned interface may be obtained.

In the battery sintered body obtained by the producing method of the battery sintered body according to the fifth embodiment, ions may move favorably for the reason that the heterogenous phase does not exist. That is to say, the battery sintered body, in which charge-discharge properties are restrained from deteriorating, may be obtained by the producing method of the battery sintered body according to the fifth embodiment. Also, the production by combination of one of an amorphous phosphate compound and a phosphate compound of a nasicon type and LiCoO₂ allows sintering at lower temperature than sintering temperature of a sintered body for existing various batteries. Incidentally, the analysis by an X-ray diffraction method is the same as the contents described in the above-mentioned fourth embodiment.

The producing method of the battery sintered body according to the fifth embodiment of the present invention is hereinafter described in each step.

(1) Intermediate Product Preparing Step

The intermediate product preparing step in the fifth embodiment is a step of preparing an intermediate product containing one of an amorphous phosphate compound and a phosphate compound of a nasicon type as a solid electrolyte material and LiCoO₂ as an active material. The intermediate product in the fifth embodiment is the same as the contents described in the above-mentioned fourth embodiment except for using LiCoO₂ as the active material; therefore, the description herein is omitted. In particular, the solid electrolyte material contained in the intermediate product is preferably heat-treated at a temperature of the crystallization temperature or higher.

(2) Sintering Step

The sintering step in the fifth embodiment is a step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method.

The sintering temperature for sintering the intermediate product is not particularly limited if the sintering temperature is a temperature such that a component except a component of the above-mentioned solid electrolyte material and a component of the above-mentioned active material is not detected, but is preferably lower. The reason therefor is that process costs may be decreased. In particular, the above-mentioned sintering temperature is preferably less than 700° C. In particular, in the case where the solid electrolyte material is Li_{1.5}Al_{0.5}Ge_{1.5}(PO₄)₃ and the active material is LiCoO₂, the sintering temperature is, for example, preferably within a range of 450° C. to 590° C., and more preferably within a range of 500° C. to 550° C. Also, the sintering time of the intermediate product and other factors are the same as the contents described in the above-mentioned fourth embodiment.

### 3. Sixth Embodiment

A sixth embodiment of the present invention is hereinafter described in detail.

A producing method of a battery sintered body according to the sixth embodiment of the present invention comprises steps of: an intermediate product preparing step of preparing an intermediate product containing one of an amorphous phosphate compound and a phosphate compound of a nasicon type as a solid electrolyte material and a transition metal oxide represented by the following general formula (2) as an active material, and a sintering step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method:

M2_{y1}O_{y2} (2)

(in the above-mentioned general formula (2), M2 is a transition metal element except Ti and has the largest possible valence, and y1 and y2 are 0≦y1 and 0≦y2).

Incidentally, the transition metal oxide represented by the above-mentioned general formula (2) is the same as is described in the items of the above-mentioned “A. Battery sintered body 3. Third Embodiment”.

According to the sixth embodiment, the production by combination of one of an amorphous phosphate compound and a phosphate compound of a nasicon type and a transition metal oxide represented by the above-mentioned general formula (2) allows the battery sintered body, in which a component except a component of the phosphate compound of a nasicon type and a component of the transition metal oxide represented by the above-mentioned general formula (2) is not detected on an interface between the phosphate compound of a nasicon type and the transition metal oxide represented by the above-mentioned general formula (2) in analyzing by an X-ray diffraction method. That is to say, the battery sintered body having no heterogenous phases on the above-mentioned interface may be obtained.

In the battery sintered body obtained by the producing method of the battery sintered body according to the sixth embodiment, ions may move favorably for the reason that the heterogenous phase does not exist. That is to say, the battery sintered body, in which charge-discharge properties are restrained from deteriorating, may be obtained by the producing method of the battery sintered body according to the sixth embodiment. Also, the production by combination of one of an amorphous phosphate compound and a phosphate compound of a nasicon type and a transition metal oxide represented by the above-mentioned general formula (2) allows sintering at lower temperature than sintering temperature of a sintered body for existing various batteries. Incidentally, the analysis by an X-ray diffraction method is the same as the contents described in the above-mentioned fourth embodiment.

The producing method of the battery sintered body according to the sixth embodiment of the present invention is hereinafter described in each step.

(1) Intermediate Product Preparing Step

The intermediate product preparing step in the sixth embodiment is a step of preparing an intermediate product containing one of an amorphous phosphate compound and a phosphate compound of a nasicon type as a solid electrolyte material and a transition metal oxide represented by the above-mentioned general formula (2) as an active material.

The intermediate product in the sixth embodiment is the same as the contents described in the above-mentioned fourth embodiment except for using a transition metal oxide represented by the above-mentioned general formula (2) as the active material; therefore, the description herein is omitted.

(2) Sintering Step

The sintering step in the sixth embodiment is a step of sintering the above-mentioned intermediate product at a temperature such that a component except a component of the above-mentioned solid electrolyte material and a component of the above-mentioned active material is not detected on an interface between the above-mentioned solid electrolyte material and the above-mentioned active material in analyzing by an X-ray diffraction method.

The sintering temperature for sintering the intermediate product is not particularly limited if the sintering temperature is a temperature such that a component except a component of the above-mentioned solid electrolyte material and a component of the above-mentioned active material is not detected, but may be properly determined in accordance with kinds of the active material and the like. Specifically, the aspects are an aspect such that the active material is Nb₂O₅ (a first aspect), an aspect such that the active material is WO₃ (a second aspect), an aspect such that the active material is MoO₃ (a third aspect), and an aspect such that the active material is Ta₂O₅ (a fourth aspect). The sintering temperature in each of the aspects is hereinafter described.

(i) First Aspect

This aspect is characterized in that the active material is Nb₂O₅. In the case where the solid electrolyte material is the amorphous Li_{1.5}Al_{0.5}Ge_{1.5}(PO₄)₃, the sintering temperature is preferably lower. The reason therefor is that process costs may be decreased. In particular, the above-mentioned sintering temperature is preferably less than 700° C.; for example, preferably within a range of 510° C. to 640° C., and more preferably within a range of 550° C. to 600° C. Also, the sintering time of the intermediate product and other factors are the same as the contents described in the above-mentioned fourth embodiment.

(ii) Second Aspect

This aspect is characterized in that the active material is WO₃. In the case where the solid electrolyte material is the amorphous Li_{1.5}Al_{0.5}Ge_{1.5}(PO₄)₃, the sintering temperature is, for example, preferably less than 950° C., above all, more preferably within a range of 510° C. to 700° C., and particularly preferably within a range of 650° C. to 700° C. Also, the sintering time of the intermediate product is the same as the contents described in the above-mentioned fourth embodiment.

(iii) Third Aspect

This aspect is characterized in that the active material is MoO₃. In the case where the solid electrolyte material is the amorphous Li_{1.5}Al_{0.5}Ge_{1.5}(PO₄)₃, the sintering temperature is, for example, preferably less than 700° C., above all, more preferably within a range of 510° C. to 650° C., and particularly preferably within a range of 600° C. to 650° C. Also, the sintering time of the intermediate product is the same as the contents described in the above-mentioned fourth embodiment.

(iv) Fourth Aspect

This aspect is characterized in that the active material is Ta₂O₅. In the case where the solid electrolyte material is the amorphous Li_{1.5}Al_{0.5}Ge_{1.5}(PO₄)₃, the sintering temperature is, for example, preferably less than 750° C., above all, more preferably within a range of 510° C. to 700° C., and particularly preferably within a range of 650° C. to 700° C. Also, the sintering time of the intermediate product is the same as the contents described in the above-mentioned fourth embodiment.

### C. All Solid Lithium Battery

A seventh embodiment of the present invention is hereinafter described in detail.

An all solid lithium battery according to the seventh embodiment of the present invention comprises the above-mentioned battery sintered body.

FIG. 5 is a cross-sectional view conceptually showing an aspect of the seventh embodiment. The all solid lithium battery in FIG. 5 has a cathode active material layer 301, an anode active material layer 302, and a solid electrolyte layer 303 formed between the cathode active material layer 301 and the anode active material layer 302. The all solid lithium battery of the present invention is greatly characterized by comprising the above-mentioned battery sintered body. For example, as shown in FIG. 1, in the case where the battery sintered body is the laminated body 150 of the solid electrolyte layer 120 and the active material layer 140, this active material layer 140 may be the cathode active material layer 301 or the anode active material layer 302 in FIG. 5. Similarly, as shown in FIG. 2, in the case where the battery sintered body is the active material layer 240, this active material layer 240 may be the cathode active material layer 301 or the anode active material layer 302 in FIG. 5.

According to the present invention, the use of the above-mentioned battery sintered body allows the all solid lithium battery excellent in output characteristics.

The all solid lithium battery of the present invention is hereinafter described in each constitution.

1. Cathode Active Material Layer

The cathode active material layer in the present invention is a layer containing at least a cathode active material, and may contain at least one of a conductive material, a solid electrolyte material and a binder, as required. In the case where the active material of the above-mentioned battery sintered body is used as an anode active material, examples of a cathode active material include LiCoO₂, LiMnO₂, Li₂NiMn₃O₈, LiVO₂, LiCrO₂, LiFePO₄, LiCoPO₄, LiNiO₂ and LiNi_{1/3}Co_{1/3}Mn_{1/3}O₂.

The cathode active material layer in the present invention may further contain a conductive material. The addition of the conductive material allows conductivity of the cathode active material layer to be improved. Examples of the conductive material include acetylene black, Ketjen Black and carbon fiber. Also, the cathode active material layer may further contain a solid electrolyte material. The addition of the solid electrolyte material allows Li ion conductivity of the cathode active material layer to be improved. Examples of the solid electrolyte material include an oxide based solid electrolyte material and a sulfide solid electrolyte material. Also, the cathode active material layer may further contain a binder. Examples of the binder include a fluorine-containing binder such as polytetrafluoroethylene (PTFE). The thickness of the cathode active material layer is preferably within a range of 0.1 μM to 1000 μm, for example.

2. Anode Active Material Layer

The anode active material layer in the present invention is a layer containing at least an anode active material, and may contain at least one of a conductive material, a solid electrolyte material and a binder, as required. In the case where the active material of the above-mentioned battery sintered body is used as a cathode active material, examples of an anode active material include a metal active material and a carbon active material. Examples of the metal active material include In, Al, Si, and Sn. On the other hand, examples of the carbon active material include mesocarbon microbeads (MCMB), high orientation property graphite (HOPG), hard carbon and soft carbon.

Incidentally, the conductive material, the solid electrolyte material and the binder used for the anode active material layer are the same as the case of the above-mentioned cathode active material layer. Also, the thickness of the anode active material layer is preferably within a range of 0.1 μm to 1000 μm, for example.

3. Solid Electrolyte Layer

The solid electrolyte layer in the present invention contains a solid electrolyte material and may contain a binder, as required. In the case where the above-mentioned battery sintered body is the active material layer (the above-mentioned FIG. 2), an optional solid electrolyte material having Li ion conductivity may be used for the solid electrolyte layer. Examples of the solid electrolyte material include an oxide based solid electrolyte material and a sulfide solid electrolyte material.

Incidentally, the binder used for the solid electrolyte layer is the same as the case of the above-mentioned cathode active material layer. Also, the thickness of the solid electrolyte layer is preferably within a range of 0.1 μm to 1000 μm, for example.

4. Other Constitutions

The all solid lithium battery of the present invention comprises at least the above-mentioned cathode active material layer, anode active material layer and solid electrolyte layer, ordinarily further comprising a current collector for collecting the cathode active material layer and the anode active material layer. Examples of a material for a cathode current collector for collecting the cathode active material layer include SOS, aluminum, nickel, iron, titanium and carbon, preferably SUS among them. On the other hand, examples of a material for an anode current collector for collecting the anode active material layer include SUS, copper, nickel and carbon, preferably SUS among them. Also, the thickness and shape of the cathode current collector and the anode current collector are preferably selected properly in accordance with uses of an all solid lithium battery and other factors. Also, a battery case of a general all solid lithium battery may be used for a battery case used for the present invention. Examples of the battery case include a battery case made of SUS. The all solid lithium battery may adopt a constitution of an electrode such that the cathode active material layer is formed on one plane of the current collector and the anode active material layer is formed on the other plane thereof, the so-called bipolar electrode. The adoption of a constitution of the bipolar electrode allows higher capacity and higher output to be achieved.

5. All Solid Lithium Battery

With regard to the all solid lithium battery of the present invention, at least one layer of the cathode active material layer, the anode active material layer and the solid electrolyte layer may be the battery sintered body, two layers among the above may be the sintered body, or all of the above may be the sintered body.

Also, the all solid lithium battery of the present invention may be a primary battery or a secondary battery, preferably a secondary battery among them. The reason therefor is to be repeatedly chargeable and dischargeable and be useful as a car-mounted battery, for example. Examples of the shape of the all solid lithium battery of the present invention include a coin shape, a laminate shape, a cylindrical shape and a rectangular shape. Also, a producing method of the all solid lithium battery of the present invention is not particularly limited if the method is a method such as to allow the above-mentioned all solid lithium battery.

Incidentally, the present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### EXAMPLES

The present invention is described more specifically while showing examples hereinafter.

### Synthesis Example 1

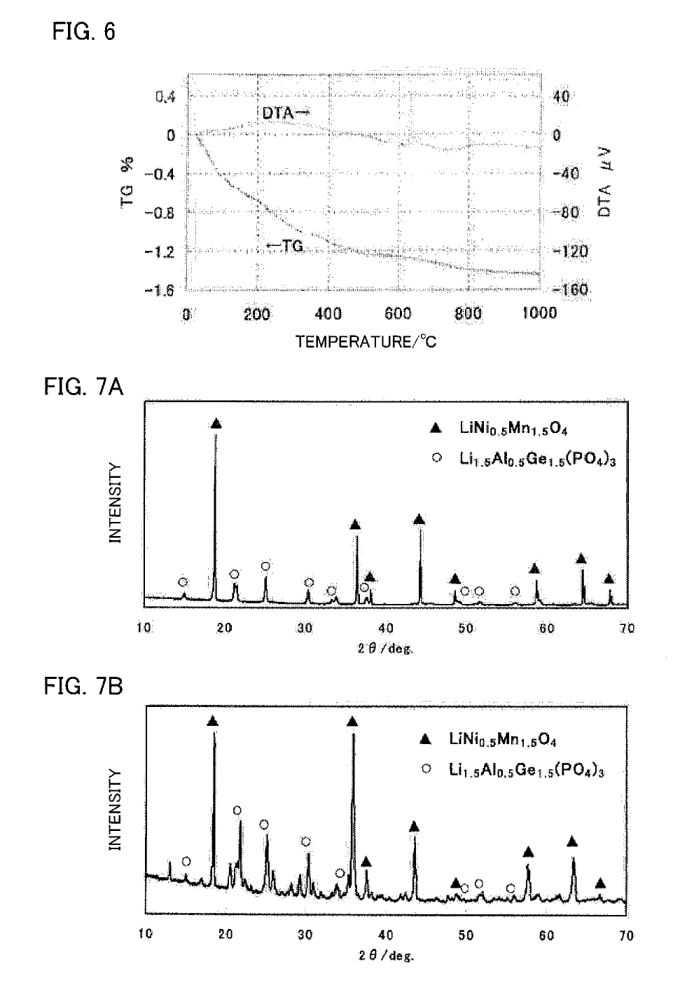

Glassy Li_{1.5}Al_{0.5}Ge_{1.5}(PO₄)₃ (LAGP, manufactured by Hosokawa Micron Group) was prepared as an amorphous phosphate compound. FIG. 6 is a TG/DTA curve of this material and it is found that the crystallization temperature thereof is 630° C. Next, the glassy Li_{1.5}Al_{0.5}Ge_{1.5}(PO₄)₃ was heat-treated (preliminarily sintered) on the conditions of an air atmosphere, 500° C. and 2 hours. The obtained test sample was ground with a mortar and thereafter sifted through a 200-mesh sieve to obtain a phosphate compound of a nasicon type (LAGP).

### Synthesis Examples 2 and 3

A phosphate compound of a nasicon type (LAGP) was obtained in the same manner as Synthesis Example 1 except for modifying the temperature for heat treatment into each of 540° C. and 650° C. Incidentally, the phosphate compound of a nasicon type obtained in Synthesis Example 3 is heat-treated at a temperature of the crystallization temperature or higher, and the phosphate compound of a nasicon type obtained in Synthesis Examples 1 and 2 is heat-treated at a temperature of the crystallization temperature or lower.

### Experimental Examples 1-1 to 1-3

The phosphate compound of a nasicon type (LAGP) obtained in Synthesis Example 1 and LiNi_{0.5}Mn_{1.5}O₄ (manufactured by Nichia Corporation, an average particle diameter of 3 μm) as an oxide of a spinel type were prepared. These were each weighed by 0.5 g and mixed by a mortar to produce pellets of φ 13 mm by pressing the obtained mixture. Next, the pellets were burnt on the conditions of an air atmosphere, 500° C. and 2 hours to obtain a battery sintered body (Experimental Example 1-1). Next, a battery sintered body was obtained in the same manner as Experimental Example 1-1 except for modifying the burning temperature into each of 550° C. and 600° C.

### Experimental Examples 1-4 to 1-6

A battery sintered body was obtained in the same manner as Experimental Examples 1-1 to 1-3 except for replacing the phosphate compound of a nasicon type obtained in Synthesis Example 1 with the phosphate compound of a nasicon type obtained in Synthesis Example 2.

### Experimental Examples 1-7 to 1-9

A battery sintered body was obtained in the same manner as Experimental Examples 1-1 to 1-3 except for replacing the phosphate compound of a nasicon type obtained in Synthesis Example 1 with the phosphate compound of a nasicon type obtained in Synthesis Example 3.

### Evaluation 1

The battery sintered body obtained in Experimental Examples 1-1 to 1-9 was ground with a mortar and subjected to X-ray diffraction (XRD) measurement. RINT UltimaIII™ manufactured by Rigaku Corporation was used for XRD measurement to use a CuKα ray. The result is shown in Table 1.

TABLE 1

| | | SINTERING | | |
|---|---|---|---|---|
| | | TEMPERATURE | | |
| | | 500° C. | 550° C. | 600° C. |
| CRYSTALLIZATION | 500° C. × 2 hr | ∘ | ∘ | x |
| TEMPERATURE OF | 540° C. × 2 hr | ∘ | ∘ | x |
| LAGP RAW MATERIAL | 650° C. × 2 hr | ∘ | ∘ | ∘ |

∘: NO IMPURITY PEAKS
x: IMPURITY PEAK CONFIRMED

As shown in Table 1, in the case of sintering Li_{1.5}Al_{0.5}Ge_{1.5}(PO₄)₃ treated at 650° C., which was higher than the crystallization temperature, and LiNi_{0.5}Mn_{1.5}O₄, it was shown that a component except a component of Li_{1.5}Al_{0.5}Ge_{1.5}(PO₄)₃ and a component of LiNi_{0.5}Mn_{1.5}O₄ was not detected in any sintering. Also, in the case of sintering Li_{1.5}Al_{0.5}Ge_{1.5}(PO₄)₃ treated at 500° C. and 540° C., which were lower than the crystallization temperature, and LiNi_{0.5}Mn_{1.5}O₄, it was shown that a component except a component of Li_{1.5}Al_{0.5}Ge_{1.5}(PO₄)₃ and a component of LiNi_{0.5}Mn_{1.5}O₄ was not detected by sintering in a range of at least 500° C. to 550° C.

Also, FIG. 7A is a result of XRD measurement of the battery sintered body obtained in Experimental Example 1-7. FIG. 7B is a result of XRD measurement of the battery sintered body obtained in Experimental Example 1-3. In FIG. 7A, a peak except Li_{1.5}Al_{0.5}Ge_{1.5}(PO₄)₃ and LiNi_{0.5}Mn_{1.5}O₄ was not confirmed. On the contrary, in FIG. 7B, a peak except Li_{1.5}Al_{0.5}Ge_{1.5}(PO₄)₃ and LiNi_{0.5}Mn_{1.5}O₄ was confirmed. This impurity phase (a heterogenous phase) might not strictly be identified and a possibility of being Li₆Ge₂O₇ is conceived.

### Experimental Examples 2-1 to 2-3

The phosphate compound of a nasicon type (LAGP) obtained in Synthesis Example 1 and LiCoO₂ (manufactured by Nichia Corporation, an average particle diameter of 10 μm) were prepared. These were each weighed by 0.5 g and mixed by a mortar to produce pellets of φ 13 mm by pressing the obtained mixture. Next, the pellets were burnt on the conditions of an air atmosphere, 500° C. and 2 hours to obtain a battery sintered body (Experimental Example 2-1). Next, a battery sintered body was obtained in the same manner as Experimental Example 2-1 except for modifying the burning temperature into each of 550° C. and 600° C.

### Experimental Examples 2-4 to 2-6

A battery sintered body was obtained in the same manner as Experimental Examples 2-1 to 2-3 except for replacing the phosphate compound of a nasicon type obtained in Synthesis Example 1 with the phosphate compound of a nasicon type obtained in Synthesis Example 2.

### Experimental Examples 2-7 to 2-9

A battery sintered body was obtained in the same manner as Experimental Examples 2-1 to 2-3 except for replacing the phosphate compound of a nasicon type obtained in Synthesis Example 1 with the phosphate compound of a nasicon type obtained in Synthesis Example 3.

### [Evaluation 2]

The battery sintered body obtained in Experimental Examples 2-1 to 2-9 was ground with a mortar and subjected to X-ray diffraction (XRD) measurement. RENT UltimaIII™ manufactured by Rigaku Corporation was used for XRD measurement to use a CuKα ray. The result is shown in Table 2.

TABLE 2

| | | SINTERING | | |
|---|---|---|---|---|
| | | TEMPERATURE | | |
| | | 500° C. | 550° C. | 600° C. |
| CRYSTALLIZATION | 500° C. × 2 hr | x | x | x |
| TEMPERATURE OF | 540° C. × 2 hr | x | x | x |
| LAGP RAW MATERIAL | 650° C. × 2 hr | ∘ | ∘ | x |

∘: NO IMPURITY PEAKS
x: IMPURITY PEAK CONFIRMED

As shown in Table 2, in the case of sintering Li_{1.5}Al_{0.5}Ge_{1.5}(PO₄)₃ treated at 650° C., which was higher than the crystallization temperature, and LiCoO₂, it was shown that a component except a component of Li_{1.5}Al_{0.5}Ge_{1.5}(PO₄)₃ and a component of LiCoO₂ was not detected by sintering in a range of at least 500° C. to 550° C.

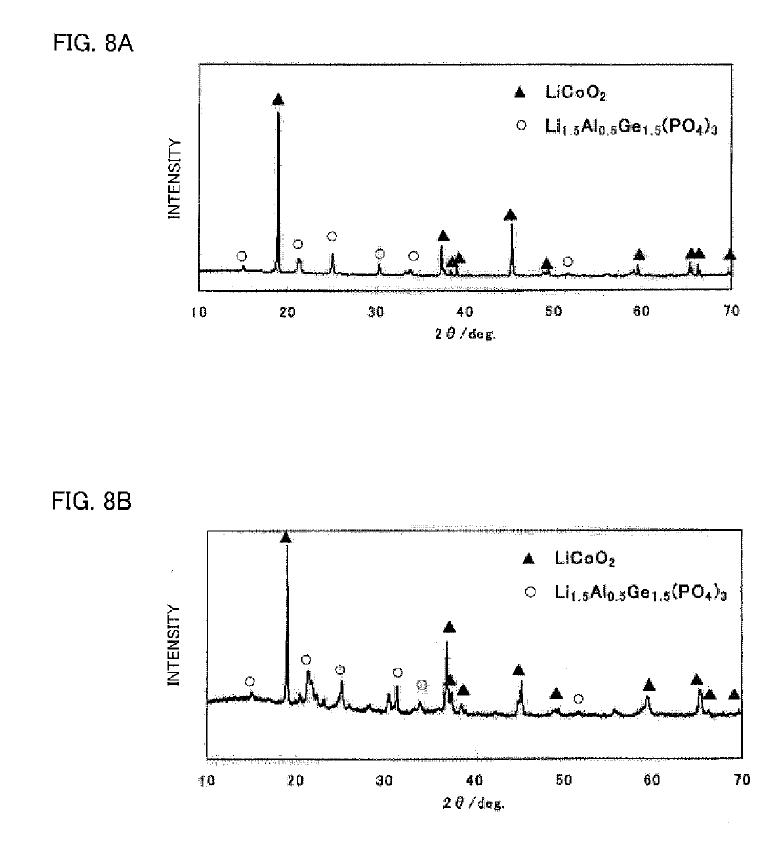

Also, FIG. 8A is a result of XRD measurement of the battery sintered body obtained in Experimental Example 2-7. FIG. 8B is a result of XRD measurement of the battery sintered body obtained in Experimental Example 2-3. In FIG. 8A, a peak except Li_{1.5}Al_{0.5}Ge_{1.5}(PO₄)₃ and LiCoO₂ was not confirmed. On the contrary, in FIG. 8B, a peak except Li_{1.5}Al_{0.5}Ge_{1.5}(PO₄)₃ and LiCoO₂ was confirmed. This impurity phase (a heterogenous phase) might not strictly be identified and a possibility of being Co₂AlO₄ and Co₃O₄ is conceived.

### Experimental Examples 3-1 to 3-4

Glassy Li_{1.5}Al_{0.5}Ge_{1.5}(PO₄)₃ (LAGP, manufactured by Hosokawa Micron Group) as an amorphous phosphate compound and Nb₂O₅ (manufactured by Aldrich, an average particle diameter of 5.0 μm) were prepared. These were mixed at a volume ratio of 50/50 by a mortar to produce pellets of φ 13 mm by pressing the obtained mixture. Next, the pellets were burnt on the conditions of an air atmosphere, 500° C. and 2 hours to obtain a battery sintered body (Experimental Example 3-1). Next, a battery sintered body was obtained in the same manner as Experimental Example 3-1 except for modifying the burning temperature into each of 550° C., 600° C. and 650° C.

### [Evaluation 3]

The battery sintered body obtained in Experimental Examples 3-1 to 3-4 was ground with a mortar and subjected to X-ray diffraction (XRD) measurement. RINT UltimaIII™ manufactured by Rigaku Corporation was used for XRD measurement to use a CuKα ray. The result is shown in Table 3.

TABLE 3

SINTERING TEMPERATURE

| | 500° C. | 550° C. | 600° C. | 650° C. |
|---|---|---|---|---|
| GLASSY LAGP | — | ∘ | ∘ | x |

∘: NO IMPURITY PEAKS
x: IMPURITY PEAK CONFIRMED

As shown in Table 3, in the case of sintering the amorphous Li_{1.5}Al_{0.5}Ge_{1.5}(PO₄)₃ and Nb₂O₅, it was shown that a component except a component of Li_{1.5}Al_{0.5}Ge_{1.5}(PO₄)₃ and a component of Nb₂O₅ was not detected by sintering in a range of at least 550° C. to 600° C.

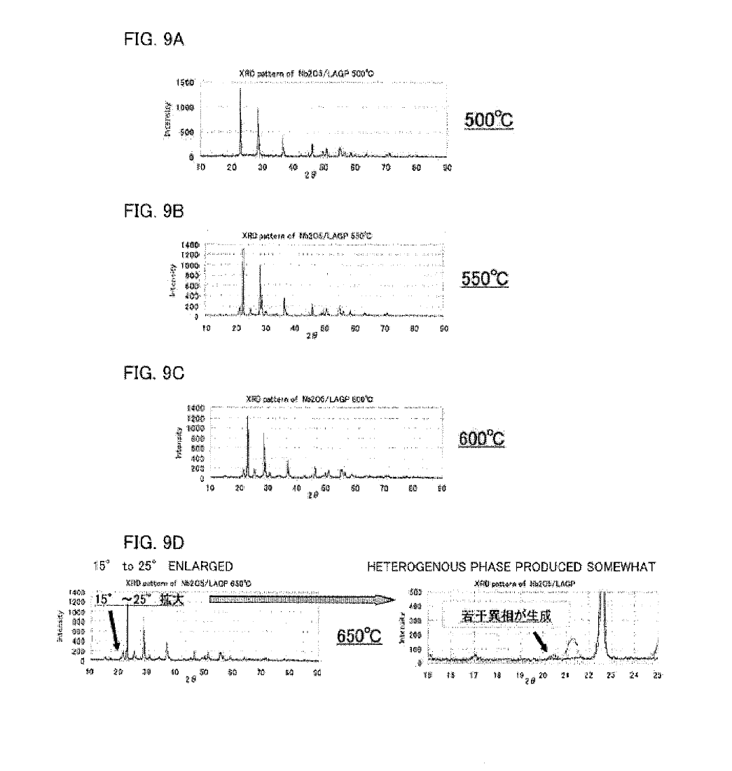

Also, FIGS. 9A to 9D are each a result of XRD measurement of the battery sintered body obtained in Experimental Examples 3-1, 3-2, 3-3 and 3-4.

In FIGS. 9B and 9D, a peak except Li_{1.5}Al_{0.5}Ge_{1.5}(PO₄)₃ and Nb₂O₅ was not confirmed. On the contrary, in FIG. 9A, a peak of Nb₂O₅ was confirmed but a peak of Li_{1.5}Al_{0.5}Ge_{1.5}(PO₄)₃ was not confirmed by reason of being amorphous. Also, in FIG. 9D, a peak except Li_{1.5}Al_{0.5}Ge_{1.5}(PO₄)₃ and Nb₂O₅ was confirmed. This impurity phase (a heterogenous phase) might not strictly be identified and a possibility of being AlPO₄, LiNbO₃ and LiNb₃O₈ is conceived.

### Experimental Examples 4-1 to 4-10

Glassy Li_{1.5}Al_{0.5}Ge_{1.5}(PO₄)₃ (LAGP, manufactured by Hosokawa Micron Group) as an amorphous phosphate compound and WO₃ (manufactured by Aldrich) were prepared. These were mixed at a volume ratio of 50/50 by a mortar to produce pellets of φ 13 mm by pressing the obtained mixture. Next, the pellets were burnt on the conditions of an air atmosphere, 500° C. and 2 hours to obtain a battery sintered body (Experimental Example 4-1). Next, a battery sintered body was obtained in the same manner as Experimental Example 4-1 except for modifying the burning temperature into each of 550° C., 600° C., 650° C., 700° C., 750° C., 800° C., 850° C., 900° C. and 950° C.

### [Evaluation 4]

The battery sintered body obtained in Experimental Examples 4-1 to 4-10 was ground with a mortar and subjected to X-ray diffraction (XRD) measurement. RINT UltimaIII™ manufactured by Rigaku Corporation was used for XRD measurement to use a CuKα ray. The result is shown in Table 4.

TABLE 4

| | SINTERING TEMPERATURE | | | | | | | | | |
|---|---|---|---|---|---|---|---|---|---|---|
| | 500° C. | 550° C. | 600° C. | 650° C. | 700° C. | 750° C. | 800° C. | 850° C. | 900° C. | 950° C. |
| GLASSY | — | ◯ | ◯ | ◯ | ◯ | ◯ | ◯ | ◯ | ◯ | — |
| LAGP | | | | | | | | | | |

◯: NO IMPURITY PEAKS

As shown in Table 4, in the case of sintering the amorphous Li_{L5}Al_{0.5}Ge_{1.5}(PO₄)₃ and NO₃, it might be confirmed that a component except a component of Li_{1.5}Al_{0.5}Ge_{1.5}(PO₄)₃ and a component of WO₃ was not detected by sintering in a range of at least 550° C. to 900° C. Incidentally, it was confirmed that the sintering was incomplete in the case of using 500° C. as the sintering temperature, while melting proceeded in the case of using 950° C. as the sintering temperature. Thus, the presence or absence of an impurity peak might not be determined.

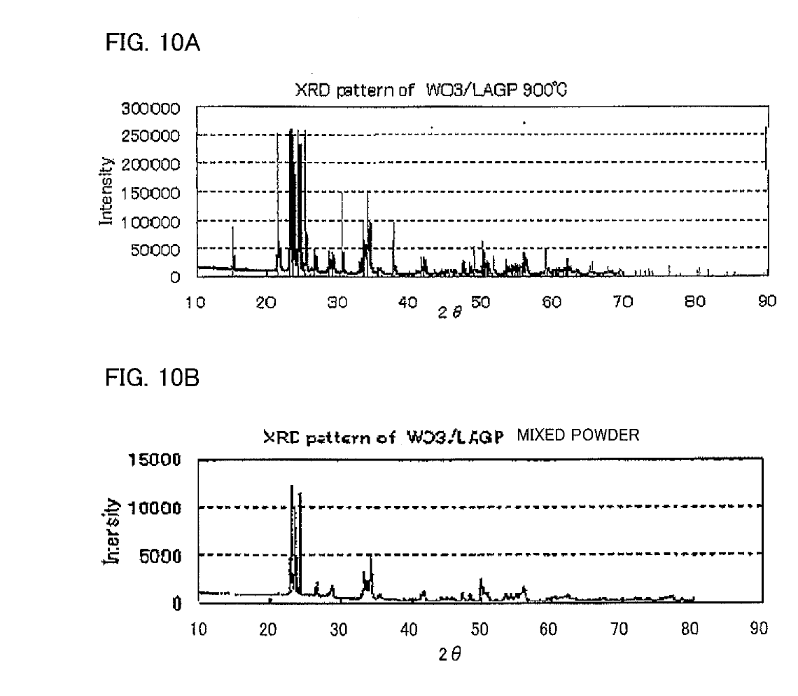

FIG. 10A is a result of XRD measurement of the battery sintered body obtained in Experimental Example 4-9, and FIG. 10B is a result of XRD measurement of mixed powder of the amorphous Li_{1.5}Al_{0.5}Ge_{1.5}(PO₄)₃ and WO₃, which are not sintered. Through these results, in FIG. 10A, a peak except the amorphous Li_{1.5}Al_{0.5}Ge_{1.5}(PO₄)₃ and WO₃ was not confirmed. Thus, it might be confirmed that impurities were not contained in the above-mentioned battery sintered body, and it was suggested that a heterogenous phase was not produced during the sintering.

### Experimental Examples 5-1 to 5-5

Glassy Li_{1.5}Al_{0.5}Ge_{1.5}(PO₄)₃ (LAGP, manufactured by Hosokawa Micron Group) as an amorphous phosphate compound and MoO₃ (manufactured by Aldrich) were prepared. These were mixed at a volume ratio of 50/50 by a mortar to produce pellets of φ 13 mm by pressing the obtained mixture. Next, the pellets were burnt on the conditions of an air atmosphere, 500° C. and 2 hours to obtain a battery sintered body (Experimental Example 5-1). Next, a battery sintered body was obtained in the same manner as Experimental Example 4-1 except for modifying the burning temperature into each of 550° C., 600° C., 650° C. and 700° C.

### [Evaluation 5]

The battery sintered body obtained in Experimental Examples 5-1 to 5- was ground with a mortar and subjected to X-ray diffraction (XRD) measurement. RINT UltimaIII™ manufactured by Rigaku Corporation was used for XRD measurement to use a CuKα ray. The result is shown in Table 5.

TABLE 5

| | SINTERING TEMPERATURE | | | | |
|---|---|---|---|---|---|
| | 500° C. | 550° C. | 600° C. | 650° C. | 700° C. |
| GLASSY LAGP | — | ∘ | ∘ | ∘ | — |

∘: NO IMPURITY PEAKS

As shown in Table 5, in the case of sintering the amorphous Li_{1.5}Al_{0.5}Ge_{1.5}(PO₄)₃ and MoO₃, it might be confirmed that a component except a component of Li_{1.5}Al_{0.5}Ge_{1.5}(PO₄)₃ and a component of MoO₃ was not detected by sintering in a range of at least 550° C. to 650° C. Incidentally, it was confirmed that the sintering was incomplete in the case of using 500° C. as the sintering temperature, while melting proceeded in the case of using 700° C. as the sintering temperature. Thus, the presence or absence of an impurity peak might not be determined.

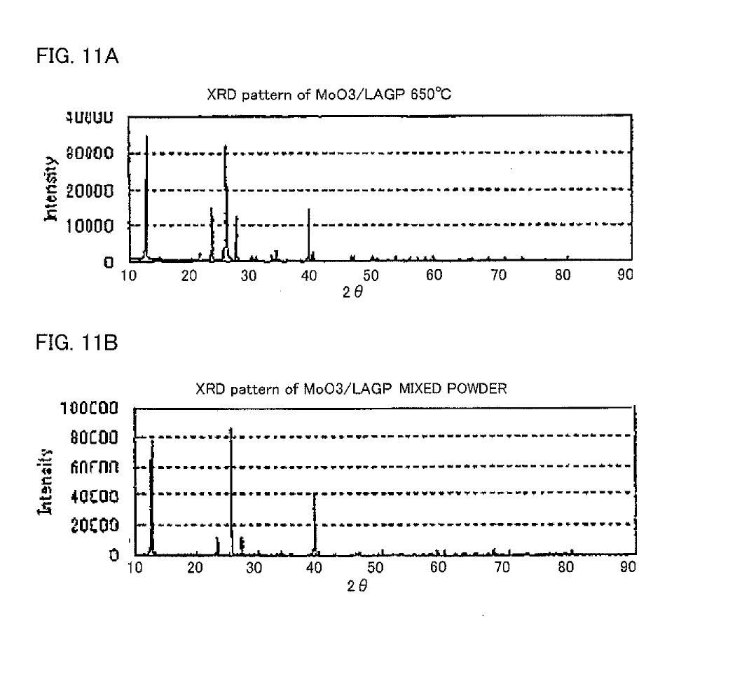

FIG. 11A is a result of XRD measurement of the battery sintered body obtained in Experimental Example 5-4, and FIG. 115 is a result of XRD measurement of mixed powder of the amorphous Li_{1.5}Al_{0.5}Ge_{1.5}(PO₄)₃ and MoO₃, which are not sintered. Through these results, in FIG. 11R, a peak except the amorphous Li_{1.5}Al_{0.5}Ge_{1.5}(PO₄)₃ and MoO₃ was not confirmed. Thus, it might be confirmed that impurities were not contained in the above-mentioned battery sintered body, and it was suggested that a heterogenous phase was not produced during the sintering.

### Experimental Examples 6-1 to 6-6

Glassy Li_{1.5}Al_{0.5}Ge_{1.5}(PO₄)₃ (LAGP, manufactured by Hosokawa Micron Group) as an amorphous phosphate compound and Ta₂O₅ (manufactured by Aldrich) were prepared. These were mixed at a volume ratio of 50/50 by a mortar to produce pellets of φ 13 mm by pressing the obtained mixture. Next, the pellets were burnt on the conditions of an air atmosphere, 500° C. and 2 hours to obtain a battery sintered body (Experimental Example 4-1). Next, a battery sintered body was obtained in the same manner as Experimental Example 4-1 except for modifying the burning temperature into each of 550° C., 600° C., 650° C., 700° C. and 750° C.

### [Evaluation 6]

The battery sintered body obtained in Experimental Examples 6-1 to 6-6 was ground with a mortar and subjected to X-ray diffraction (XRD) measurement. RINT UltimaIII™ manufactured by Rigaku Corporation was used for XRD measurement to use a CuKα ray. The result is shown in Table 6.

TABLE 6

| | SINTERING TEMPERATURE | | | | | |
|---|---|---|---|---|---|---|
| | 500° C. | 550° C. | 600° C. | 650° C. | 700° C. | 750° C. |
| GLASSY | — | ◯ | ◯ | ◯ | ◯ | X |
| LAGP | | | | | | |

◯: NO IMPURITY PEAKS
X: IMPURITY PEAK CONFIRMED

As shown in Table 6, in the case of sintering the amorphous Li_{1.5}Al_{0.5}Ge_{1.5}(PO₄)₃ and Ta₂O₅, it might be confirmed that a component except a component of Li_{1.5}Al_{0.5}Ge_{1.5}(PO₄)₃ and a component of Ta₂O₅ was not detected by sintering in a range of at least 550° C. to 700° C. Incidentally, in the case of using 750° C. as the sintering temperature, an impurity peak was confirmed. Meanwhile, in the case of using 500° C. as the sintering temperature, the sintering was incomplete and the presence or absence of an impurity peak might not be determined.

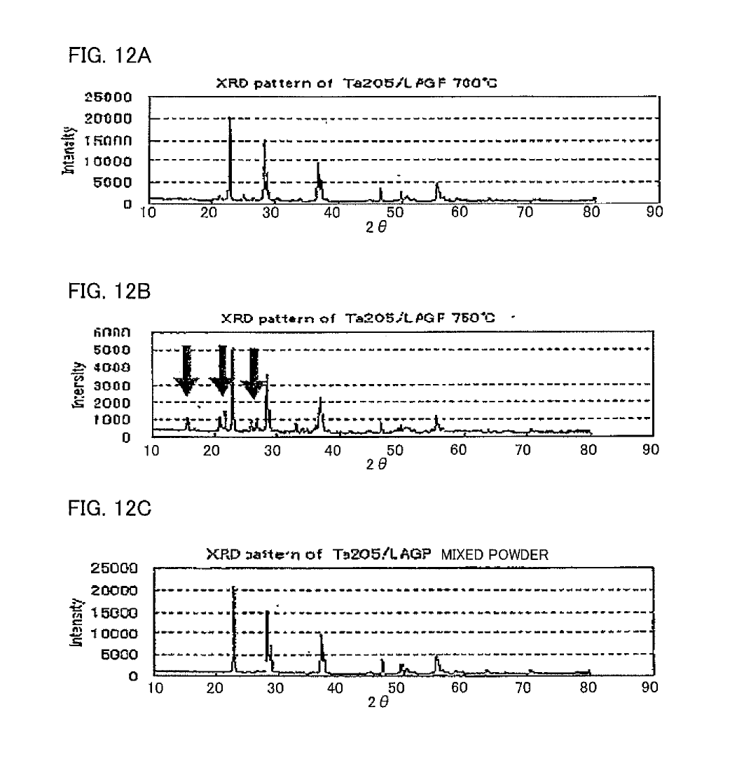

FIGS. 12A and 125 are a result of XRD measurement of the battery sintered body obtained in Experimental Examples 6-5 and 6-6, and FIG. 12C is a result of XRD measurement of mixed powder of the amorphous Li_{1.5}Al_{0.5}Ge_{1.5}(PO₄)₃ and Ta₂O₅, which are not sintered. Through these results, in FIG. 12A, a peak except the amorphous Li_{1.5}Al_{0.5}Ge_{1.5}(PO₄)₃ and Ta₂O₅ was not confirmed. Thus, it might be confirmed that impurities were not contained in the above-mentioned battery sintered body, and it was suggested that a heterogenous phase was not produced during the sintering. Meanwhile, in FIG. 12B, a peak except the amorphous Li_{1.5}Al_{0.5}Ge_{1.5}(PO₄)₃ and Ta₂O₅ was confirmed. It is conceived that this impurity phase (a heterogenous phase) is derived from TaPO₅.

### REFERENCE SIGNS LIST

11, 21, 110, 210 . . . Solid electrolyte material
12, 120, 303 . . . Solid electrolyte layer
13, 23, 130, 230 . . . Active material
14, 24, 140, 240 . . . Active material layer
15, 150 . . . Laminated body
301 . . . Cathode active material layer
302 . . . Anode active material layer

1-21. (canceled)

22. A battery sintered body, comprising:
a compound represented by a general formula of Li₁₊ₓAlₓGe₂₋ₓ(PO₄)₃ (0≦x≦2) as a solid electrolyte material; and
an oxide of a spinel type containing Ni and Mn as an active material,
wherein a component except a component of the solid electrolyte material and a component of the active material is not detected on an interface between the solid electrolyte material and the active material in analyzing by an X-ray diffraction method.

23. The battery sintered body according to claim 22, wherein the active material is represented by the following general formula (1):
LiNiₓMn₂₋ₓO₄ (1)
(in the general formula (1), x is 0<x<2).

24. The battery sintered body according to claim 22, wherein the active material is LiNi_{0.5}Mn_{1.5}O₄.

25. A battery sintered body, comprising:
a compound represented by a general formula of Li₁₊ₓAlₓGe₂₋ₓ(PO₄)₃ (0≦x≦2) as a solid electrolyte material; and
LiCoO₂ as an active material,
wherein a component except a component of the solid electrolyte material and a component of the active material is not detected on an interface between the solid electrolyte material and the active material in analyzing by an X-ray diffraction method.

26. A battery sintered body, comprising:
a phosphate compound of a nasicon type as a solid electrolyte material; and
a transition metal oxide represented by the following general formula (2) as an active material,
wherein a component except a component of the solid electrolyte material and a component of the active material is not detected on an interface between the solid electrolyte material and the active material in analyzing by an X-ray diffraction method:
M2_{y1}O_{y2} (2)
(in the general formula (2), M2 is a transition metal element except Ti and has the largest possible valence, and y1 and y2 are 0≦y1 and 0≦y2).

27. The battery sintered body according to claim 26, wherein the active material is Nb₂O₅.

28. The battery sintered body according to claim 26, wherein the active material is WO₃.

29. The battery sintered body according to claim 26, wherein the active material is MoO₃.

30. The battery sintered body according to claim 26, wherein the active material is Ta₂O₅.

31. The battery sintered body according to claim 26, wherein the solid electrolyte material is represented by the following general formula (3):
Li_{1+z}M3_{z}M4_{2-z}(PO₄)₃ (3)
(in the general formula (3), M3 is at least one kind selected from the group consisting of Al, Y, Ga and In, M4 is at least one kind selected from the group consisting of Ti, Ge and Zr, and z is 0≦z≦2).

32. The battery sintered body according to claim 22, wherein the solid electrolyte material is Li_{1.5}Al_{0.5}Ge_{1.5}(PO₄)₃.

33. The battery sintered body according to claim 25, wherein the solid electrolyte material is Li_{1.5}Al_{0.5}Ge_{1.5}(PO₄)₃.

34. The battery sintered body according to claim 26, wherein the solid electrolyte material is Li_{1.5}Al_{0.5}Ge_{1.5}(PO₄)₃.

35. A producing method of a battery sintered body, comprising steps of:
an intermediate product preparing step of preparing an intermediate product containing one of an amorphous phosphate compound and a compound represented by a general formula of Li₁₊ₓAlₓGe₂₋ₓ(PO₄)₃ (0≦x≦2) as a solid electrolyte material, and an oxide of a spinel type containing Ni and Mn as an active material; and
a sintering step of sintering the intermediate product at a temperature such that a component except a component of the solid electrolyte material and a component of the active material is not detected on an interface between the solid electrolyte material and the active material in analyzing by an X-ray diffraction method.

36. The producing method of a battery sintered body according to claim 35, further comprising a preliminary sintering step of obtaining the compound represented by a general formula of Li₁₊ₓAlₓGe₂₋ₓ(PO₄)₃ (0≦x≦2) as the solid electrolyte material by sintering the amorphous phosphate compound.

37. The producing method of a battery sintered body according to claim 36, wherein a temperature of the sintering of the amorphous phosphate compound is higher than a crystallization temperature of the amorphous phosphate compound.

38. A producing method of a battery sintered body, comprising steps of:
an intermediate product preparing step of preparing an intermediate product containing one of an amorphous phosphate compound and a compound represented by a general formula of Li₁₊ₓAlₓGe₂₋ₓ(PO₄)₃ (0≦x≦2) as a solid electrolyte material, and LiCoO₂ as an active material; and
a sintering step of sintering the intermediate product at a temperature such that a component except a component of the solid electrolyte material and a component of the active material is not detected on an interface between the solid electrolyte material and the active material in analyzing by an X-ray diffraction method.

39. A producing method of a battery sintered body, comprising steps of:
an intermediate product preparing step of preparing an intermediate product containing one of an amorphous phosphate compound and a phosphate compound of a nasicon type as a solid electrolyte material, and a transition metal oxide represented by the following general formula (2) as an active material; and
a sintering step of sintering the intermediate product at a temperature such that a component except a component of the solid electrolyte material and a component of the active material is not detected on an interface between the solid electrolyte material and the active material in analyzing by an X-ray diffraction method:
M2_{y1}O_{y2} (2)
(in the general formula (2), M2 is a transition metal element except Ti and has the largest possible valence, and y1 and y2 are 0≦y1 and 0≦y2).

40. The producing method of a battery sintered body according to claim 39, wherein the active material is Nb₂O₅.

41. The producing method of a battery sintered body according to claim 39, wherein the active material is WO₃.

42. The producing method of a battery sintered body according to claim 39, wherein the active material is MoO₃.

43. The producing method of a battery sintered body according to claim 39, wherein the active material is Ta₂O₅.

44. An all solid lithium battery, comprising the battery sintered body according to claim 22.

45. An all solid lithium battery, comprising the battery sintered body according to claim 25.

46. An all solid lithium battery, comprising the battery sintered body according to claim 26.
